(19) United States
(12) Patent Application Publication
(10) Pub. No.: US 2026/0163372 A1
(43) Pub. Date: Jun. 11, 2026

(54) DATA PRIVACY PRESERVING METHOD AND SYSTEM FOR PROBABILISTIC RENEWABLE POWER GENERATION SEQUENCE FORECASTING

(71) Applicant: City University of Hong Kong, Kowloon (HK)

(72) Inventors: Hong LIU, Shenzhen (CN); Xinuo ZHAO, Kowloon (HK); Zijun ZHANG, Kowloon Tong (HK)

(21) Appl. No.: 19/383,995

(22) Filed: Nov. 10, 2025

Related U.S. Application Data
(60) Provisional application No. 63/730,932, filed on Dec. 11, 2024.

(51) Int. Cl. H02J 3/00

(52) U.S. Cl. CPC H02J 3/004; H02J 2103/30

(57) ABSTRACT

A method for probabilistic forecast of day-ahead power generation sequences of a plurality of renewable power plants. The method includes the steps of: a) for each one of a plurality of client devices, mapping its raw data input to latent features; b) transmitting a locally hosted forecasting model in the form of the latent features and model parameters of each client device to a server; c) aggregating the locally hosted forecasting models of the plurality of client devices at the server; d) dispatching the aggregated models to the client devices; e) updating the locally hosted forecasting model on each client device based on the aggregated models; and f) generating, at each client device, power output sequence probabilistic forecasts based on the updated locally hosted forecasting model. The plurality of client devices each corresponds to a respective one of the plurality of renewable power plants. The plurality of client devices is connected to the server.

### FIELD OF INVENTION

This invention relates to renewable power plants, and in particular to probabilistic forecasting of renewable power plants.

### BACKGROUND OF INVENTION

Renewables, including wind and solar energy, are crucial for achieving carbon neutrality and have maintained a rapid pace of growth worldwide [1]. The significance of studying renewable power forecasting (RPF) methods for tackling the uncertainty of renewable power generations in power grid operations has been well recognized [2]. Accurate and reliable forecasts of renewable power generation are essential for power grid operations, enabling grid operators to better anticipate sudden changes in power production caused by renewable sources. For instance, as discussed in [3], the improved forecasting techniques can better reduce ramp rate violations significantly. Depending on the forecasting horizon, RPF tasks can be briefly classified as short-term (0-6 h ahead), medium-term (6-24 h ahead), or long-term (more than 24 h ahead) forecasting tasks [4]. Methods considering different forecasting horizons can offer different practical values. Results of RPFs covering a longer period of future points are beneficial to a variety of downstream tasks, such as electricity pricing [5], unit commitment [6], storage management [7], power plant maintenance [8], and power trading [9]. However, the accumulation of uncertainty in renewable resource supply over the forecasting horizon makes such a RPF task quite challenging.

The centric topic in RPF studies is forecasting model development. The past wide deployment of supervisory control and data acquisition (SCADA) systems in commercial renewable power plants has led to an unprecedented opportunity of shifting RPF studies from considering traditional physics-based models [10] and statistics-based models [11] to nowadays data-driven ones including classical machine learning models [12] and latest deep learning models [13]. According to the concerned output type, the RPF tasks be categorized into two streams, the deterministic and probabilistic RPF. Deterministic RPF aims to estimate the future spot value and has been extensively studied in literature. In comparison, probabilistic RPF attempts to quantify uncertainties of future renewable power outputs by providing the confidence intervals, quantiles, or distributions of forecasts. As the probabilistic RPF possesses the ability for quantifying uncertainties of renewable power outputs, generated results convey richer information to the risk assessment and operational decision-makings of power systems [14].

The main body of the probabilistic RPF literature falls into exploring methods of various forms for better probabilistic forecasting performances. Both parametric and non-parametric probabilistic RPF methods have been widely discussed. Parametric methods typically specify a form of predictive density, such as the Gaussian or Beta, which only depends on a few parameters. In [15], a Bayesian information criterion (BIC) was utilized to select the best parameter of sparse vector auto-regression algorithm for RPF. In [16], a modified Taylor Kriging method was developed to estimate parameters of the future renewable power generation density. Non-parametric methods, on the other hand, quantify the renewable power output uncertainty via estimating confidence intervals, quartiles, and distributions without any assumptions of distribution shapes. Quantile regressions (QR) [17, 18] and Lower upper bound estimation methods (LUBE) [19, 20], which aim at estimating confidence intervals (CI) directly, were applied to studying the probabilistic RPF. In [17], a temporal convolutional QR combining QR and temporal convolutional network (TCN) was proposed to estimate the quantile of wind power. In [19], a neural network-based LUBE and moving block bootstrap method were proposed for probabilistic RPF. In [20], the LUBE combined with the recurrent neural network (RNN) was developed to enhance the RPF. Besides forecasting intervals, Kernel density estimation (KDE) methods [21, 22] were developed to infer the distribution of the future power output and realize the RPF. In [21], a bivariate vector autoregressive moving average-generalized autoregressive conditional heteroscedastic method was applied to RPF. In [22], KDE models with four bandwidth selectors were introduced to RPF. Recently, a more flexible paradigm for developing the probabilistic forecasting models, the mixture density network (MDN) [23-29], was observed. Compared with KDE, MDN utilized a mixture model with multiple components rather than a single-kernel distribution to realize higher flexibility in modeling and more accurate forecasts. The study [23] integrated CNN and GRU to form an inference network in MDN while regarded Gaussian mixture model (GMM) as the probability density function (PDF) due to its simplicity and convenience for sampling and computing the likelihood. However, the GMM may cause density leakage problems in the mixture model. The study [24] addressed this issue by replacing the GMM with the beta kernel MDN. The study [25] further improved the MDN by using a Wasserstein distance-based adversarial learning algorithm to train the model.

Most previous probabilistic RPF studies [15-29] were devoted into developing more sophisticated methods for advancing forecasting performance with ideally presuming a perfect data accessibility. Meanwhile, due to motivation of leveraging richer information to develop more meaningful features for forecasting, a few recent studies [4, 32, 33] considered a much wider data accessibility, data collected from multiple sources. As summarized in Table I, based on recent literature [31-36], one can clearly observe two tracks of research developments on RPF: 1) advancing network architectures for long term RPF tasks based on data of the targeted renewable sources; and 2) designing network architectures utilizing data from multiple data sources. However, the presumed full data accessibility in the previous research can form a great burden regarding real application scenarios with data privacy and safety concerns [43]. Moreover, due to data sharing regulations, forecasting with accessing data from distributed renewable energy units in different power plants located in various regions may not always be possible.

To address the data privacy concern in data-driven modeling, the federated learning (FL) paradigm [44-46] has been proposed. The FL paradigm following a client-server scheme includes multiple clients corresponding to power plants, where local data are collected, and a server, where the desensitized local data and models are aggregated. In recent literature, various FL based methods have been developed for RPF tasks with privacy preserving [37-42, 44, 46, 49]. In [44], a generic FedAvg framework was applied to utilize the data from different sources without breaching privacy. In [49], a personalized federated learning (PFL) strategy was adopted to enable enhancement of the robustness against anomalous updates from individual wind farms. According to [37-42], it is observable that discussions of the FL-based RPF method development largely focused on addressing privacy-preserving for deterministic RPF problems while the probabilistic RPF with preserving privacy were relatively scarce. Moreover, most studies [37-42, 49] aimed to address short-term RPF tasks. In the realm of renewable energy forecasting, day-ahead sequence forecasting compared to short-term forecasting only offers a more inclusive feature as the sequence forecasted already covers the period considered in many short-term forecasting studies [30-33]. Meanwhile, the consideration of data privacy protection in the model development for probabilistic sequence forecasting presents a value-added service. As day-ahead forecasts play a pivotal role in operations planning, energy trading, and market participation, forecasting, which enables enjoying richer spectrum of information in modeling without breaching the local data privacy, can bring benefits into modeling while prevent unfair competition caused by disclosing data and the misuse of information [50]. Hence, from a more practical aspect, it is more valuable to study modeling with privacy preserving under the probabilistic day-ahead renewable power sequence forecasting (DRPSF).

### REFERENCES

Each of the following references (and associated appendices and/or supplements) is expressly incorporated herein by reference in its entirety:
[1] S. Letzgus S, K. R. Müller. An explainable AI framework for robust and transparent data-driven wind turbine power curve models. Energy and AI, 2024, 15:100328.
[2] H. Chen, A novel wind model downscaling with statistical regression and forecast for the cleaner energy. Journal of Cleaner Production 434(2024): 140217.
[3] X. Peng, Y. Li, F. Tsung. A Graph Attention Network with Spatio-Temporal Wind Propagation Graph for Wind Power Ramp Events Prediction. Renewable Energy 236(2024) 121280.
[4] M. Khodayar, J. Wang. Spatio-temporal graph deep neural network for short-term wind speed forecasting. IEEE Transactions on Sustainable Energy 10(2) (2018) 670-681.
[5] J. Trebbien, L. R. Gorjão, A. Praktiknjo, et al. Understanding electricity prices beyond the merit order principle using explainable AI. Energy and AI, 2023, 13:100250.
[6] J. Wang, M. Shahidehpour, Z. Li. Security-constrained unit commitment with volatile wind power generation. IEEE Transactions on Power Systems 23(3) (2008) 1319-1327.
[7] R. Blonbou, S. Monjoly, J. F. Dorville. An adaptive short-term prediction scheme for wind energy storage management. Energy conversion and management 52(6) (2011) 2412-2416.
[8] H. Sharma H, L. Marinovici, V. Adetola, et al. Data-driven modeling of power generation for a coal power plant under cycling. Energy and AI, 2023, 11:100214.
[9] A. Pircalabu, T. Hvolby, J. Jung, E. Høg. Joint price and volumetric risk in wind power trading: A copula approach. Energy Economics 62(2017) 139-154.
[10] U. Focken, M. Lange, H. P. Waldl, Previento-a wind power prediction system with an innovative upscaling algorithm in Proceedings of the European Wind Energy Conference, Copenhagen, Denmark 276(2001).
[11] X. Liu, Z. Lin, Z. Feng. Short-term offshore wind speed forecast by seasonal ARIMA-A comparison against GRU and LSTM. Energy 227(2021) 120492.
[12] S. Wang, B. Li B, G. Li, et al. A Comprehensive Review on the Development of Data-Driven Methods for Wind Power Prediction and AGC Performance Evaluation in Wind-Thermal Bundled Power Systems. Energy and AI, 2024:100336.
[13] J. Zhu, L. Su, Y. Li, Wind power forecasting based on new hybrid model with TCN residual modification. Energy and AI, 2022, 10:100199.
[14] Z. Zheng, Z. Zhang, A Stochastic Recurrent Encoder Decoder Network for Multistep Probabilistic Wind Power Predictions, IEEE Transactions on Neural Networks and Learning Systems (2023).
[15] J. Dowell, P. Pinson, Very-Short-Term Probabilistic Wind Power Forecasts by Sparse Vector Auto-regression, IEEE Transactions on Smart Grid 7(2015) 736-770.
[16] H. Liu, J. Shi, E. Erdem, Prediction of wind speed time series using modified Taylor Kriging method, Energy 35(2010) 4870-4879.
[17] J. Hu, Q. Luo, J. Heng, Y. Deng, Conformalized temporal convolutional quantile regression networks for wind power interval forecasting, Energy 248 (2022) 123497.
[18] J. Hu, J. Tang, Y. Lin. A novel wind power probabilistic forecasting approach based on joint quantile regression and multi-objective optimization. Renewable Energy 149(2020) 141-164.
[19] A. Khosravi, S. Nahavandi, D. Creighton, Prediction intervals for short-term wind farm power gen-eration forecasts, IEEE Transactions on sustainable energy 5(2013) 602-610.
[20] Z. Shi Z, H. Liang, V. Dinavahi. Direct interval forecast of uncertain wind power based on recurrent neural networks, IEEE Transactions on sustainable energy 9(2017) 1177-1187.
[21] J. Jeon, J. W. Taylor, Using conditional kernel density estimation for wind power density forecasting, Journal of the American Statistical Association 107 (2012) 66-79.
[22] Q. Han, S. Ma, T. Wang, F. Chu, Kernel density estimation model for wind speed probability distribution with applicability to wind energy assessment in China, Renewable and Sustainable Energy Reviews, 115(2019) 109387.
[23] M. Afrasiabi, M. Mohammadi, M. Rastegar, S. Afrasiabi Advanced deep learning approach for probabilistic wind speed forecasting, IEEE Transactions on Industrial Informatics 17(2020) 720-727.
[24] Z. Men, E. Yee, F. S. Lien, et al. Short-term wind speed and power forecasting using an ensemble of mixture density neural networks. Renewable Energy 87 (2016) 203-211.
[25] L. Yang, Z. Zheng, Z. Zhang, An Improved Mixture Density Network Via Wasserstein Distance Based Adversarial Learning for Probabilistic Wind Speed Predictions, IEEE Transactions on Sustainable Energy 13, (2021) 755-766.
[26] A. Brusaferri, M. Matteucci, S. Spinelli, et al. Probabilistic electric load forecasting through Bayesian mixture density networks. Applied Energy 309 (2022) 118341.
[27] R. Raidoo, R. Laubscher, Data-driven forecasting with model uncertainty of utility-scale air-cooled condenser performance using ensemble encoder-decoder mixture-density recurrent neural networks, Energy 238(2022) 122030.
[28] Z. Zheng, Z. Zhang. A stochastic recurrent encoder decoder network for multistep probabilistic wind power predictions. IEEE Transactions on Neural Networks and Learning Systems, in press, 2023.
[29] H. Xue, Y. Jia, P. Wen, G. Saeid, Using of improved models of Gaussian Processes in order to Regional wind power forecasting, Journal of Clean Production 262(2020) 121391.
[30] M. Yang, D. Wang, W. Zhang. A short-term wind power prediction method based on dynamic and static feature fusion mining. Energy 280(2023) 128226.
[31] M. A. Hossain, E. Gray, J. Lu, et al. Optimized forecasting model to improve the accuracy of very short-term wind power prediction. IEEE Transactions on Industrial Informatics 19(10) (2019) 10145-10159.
[32] H. Liu H, L. Yang, B. Zhang, et al. A two-channel deep network based model for improving ultra-short-term prediction of wind power via utilizing multi-source data. Energy 283(2023) 128510.
[33] C. A. Severiano, P. C. L. e Silva, M. W. Cohen, et al. Evolving fuzzy time series for spatio-temporal forecasting in renewable energy systems. Renewable Energy 171(2021) 764-783.
[34] C. Wan, Z. Xu, P. Pinson, et al. Probabilistic forecasting of wind power generation using extreme learning machine. IEEE Transactions on Power Systems 29(3) (2013) 1033-1044.
[35] J. J. Mesa-Jiménez, A. L. Tzianoumis, L. Stokes, et al. Long-term wind and solar energy generation forecasts, and optimisation of Power Purchase Agreements. Energy Reports 9(2023) 292-302.
[36] A. Ahmadi A, M. Nabipour, B. Mohammadi-Ivatloo, et al. Long-term wind power forecasting using tree-based learning algorithms. IEEE Access 8(2020) 151511-151522.
[37] C. Goncalves, J. B. Ricardo, and P Pinson. “Privacy-preserving distributed learning for renewable energy forecasting.” IEEE Transactions on Sustainable Energy 12.3(2021): 1777-1787.
[38] Y. Li, et al. “Wind power forecasting considering data privacy protection: A federated deep reinforcement learning approach.” Applied Energy 329(2023): 120291.
[39] X. Zhang, F Fang, J Wang. “Probabilistic solar irradiation forecasting based on variational Bayesian inference with secure federated learning.” IEEE Transactions on Industrial Informatics 17.11(2020): 7849-7859.
[40] L. Zhang, S. Zhu, S. Su, et al. Wind power prediction method based on cloud computing and data privacy protection. Journal of Cloud Computing, 2024, 13(1): 1-14.
[41] Y. Wang Y, Q. Guo. Privacy-Preserving and Adaptive Federated Deep Learning for Multiparty Wind Power Forecasting. IEEE Transactions on Industry Applications, 2024.
[42] A. Alshardan, S. Tariq, R. N. Bashir, et al. Federated Learning (FL) Model of Wind Power Prediction. IEEE Access, 2024.
[43] Y. Li, J. Li, Y. Wang, Privacy-preserving spatiotemporal scenario generation of renewable energies: A federated deep generative learning approach, IEEE Transactions on Industrial Informatics (2021).
[44] K. Bonawitz, H. Eichner, W. Grieskamp, D. Huba, A. Ingerman, V. Ivanov, et al, Towards Federated Learning at Scale: System Design, in proceedings of Machine Learning and Systems 1(2019) 374-388.
[45] T. Li, A. K. Sahu, A. Talwalkar, Federated learning: Challenges, methods, and future directions, IEEE Signal Processing Magazine 37(2020) 50-60.
[46] L. Li, Y. Fan, M. Tse, K. Y. Lin, A review of applications in federated learning, Computers & Industrial Engineering 149(2020) 106854.
[47] X. Zhao, B. Sun, and R. Geng, A new distributed decomposition-reconstruction-ensemble learning para-digm for short-term wind power prediction. Journal of Cleaner Production 423(2023) 138676.
[48] Y. Qiang, Y. Liu, T. Chen, Y. Tong. Federated Machine Learning: Concept and Applications, ACM Transactions on Intelligent Systems and Technology 10 (2019) 1-19.
[49] Y. Zhao, S. Pan, Y. Zhao, et al. Ultra-short-term wind power forecasting based on personalized robust federated learning with spatial collaboration. Energy 288 (2024) 129847.
[50] Y. Li, R. Wang, Y. Li, M. Zhang, C. Long, Wind power forecasting considering data privacy protection: A federated deep reinforcement learning approach, Applied Energy 329(2023) 120291.
[51] H. Liu and Z. Zhang. Development and Trending of Deep Learning Methods for Wind Power Predictions. Artificial Intelligence Review 57(2024) 112.

### SUMMARY OF INVENTION

In the light of the foregoing background, it is an object of the present invention to study the renewable power forecasting task with a more advanced formulation, the probabilistic forecasts of day-ahead power generation sequences of multiple renewable power plants without breaching the privacy of data in each plant.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

According to a first aspect of the invention, there is provided a method for probabilistic forecast of day-ahead power generation sequences of a plurality of renewable power plants. The method includes the steps of: a) for each one of a plurality of client devices, mapping its raw data input to latent features; b) transmitting a locally hosted forecasting model in the form of the latent features and model parameters of each client device to a server; c) aggregating the locally hosted forecasting models of the plurality of client devices at the server; d) dispatching the aggregated models to the client devices; e) updating the locally hosted forecasting model on each client device based on the aggregated models; and f) generating, at each client device, power output sequence probabilistic forecasts based on the updated locally hosted forecasting model. The plurality of client devices each corresponds to a respective one of the plurality of renewable power plants. The plurality of client devices is connected to the server.

In some embodiments, for each one of the plurality of client devices, the step of mapping the raw data input to latent features is conducted by a local feature extractor on the client device.

In some embodiments, the local feature extractor is a Deep Neural Network (DNN), a Convolutional Neural Networks (CNN), a Long Short-Term Memory networks (LSTM), or a Gated Recurrent Units (GRU).

In some embodiments, in Step a) the local feature extractor is assisted by a discriminator on the server in identifying domain-invariant features.

In some embodiments, the latent features are domain-invariant features.

In some embodiments, the model parameters are generated on each client device by a local probabilistic estimator of the client device.

In some embodiments, the server contains a global feature extractor, a global probabilistic estimator, and a discriminator.

In some embodiments, the global feature extractor is adapted to aggregate all latent features from the plurality of client devices. The global probabilistic estimator is adapted to aggregate all model parameters from the plurality of client devices.

In some embodiments, the aggregated models contain aggregated latent features and aggregated model parameters, which are used to updated a local feature extractor and a local probabilistic estimator on each of the plurality of client devices.

In some embodiments, the discriminator is adapted to classify domain label of the latent features.

In some embodiments, the above steps of mapping its raw data input to latent features to updating the locally hosted forecasting model on each client device are repeatedly performed in a plurality of iterations in order to train the locally hosted forecasting models.

In some embodiments, the method further includes a step of training, using a training dataset and a validation dataset, the local probabilistic estimator on at least one said client device to maximize a log likelihood of the probabilistic forecast of the local probabilistic estimator.

In some embodiments, the method further includes a step of training, using features generated by a plurality of local feature extractors respectively located on the plurality of client device from different domains, the discriminator to maximize a log likelihood that a forecast label equals a domain label.

In some embodiments, the method further includes a step of training the local feature extractor on at least one said client device using a combined loss of training a local probabilistic estimator on at least one said client device and training a discriminator on the server.

According to another aspect of the invention, there is provided a system for probabilistic forecast of day-ahead power generation sequences of a plurality of renewable power plants, the system includes one or more processors; and memory storing one or more programs configured to be executed by the one or more processors. The one or more programs include instructions for executing the method as described above or its variants.

According to a further aspect of the invention, there is provided a non-transitory computer-readable storage medium storing one or more programs configured to be executed by one or more processors, the one or more programs including instructions for executing the method as described above or its variants.

According to a further aspect of the invention, there is provided a system for probabilistic forecast of day-ahead power generation sequences of a plurality of renewable power plants. The system includes a server, and a plurality of client devices connected to the server. The server is adapted to aggregate locally hosted forecasting models from the plurality of client devices, and to dispatch the aggregated models to the client devices. The locally hosted forecasting models received by the server contain latent features and model parameters of the locally hosted forecasting models.

According to a further aspect of the invention, there is provided a method for the probabilistic forecasts of day-ahead power generation sequences of multiple renewable power plants without breaching the privacy of data in each plant. The method includes: implementing a “server-client” based system coordinating network-based models for simultaneously forecasting day-ahead power generation sequences of wind turbines and solar panels in multiple renewable power plants; hosting a network based local feature extractor and a network based probabilistic forecaster via decoding extracted features on client sides; maintaining the global version of the feature extractor and probabilistic forecaster as well as develops a discriminator network on the server side.

In some embodiments, the “server-client” designation is consisting of multiple client-side networks located locally in renewable power plants and a global network hosted in the cloud-based server.

In some embodiments, the total framework is based on deep network models.

In some embodiments, the local probabilistic estimator in client structure is the mixture density network, which is a fully connected neural network.

In some embodiments, the four widely applied deep networks, the DNN, CNN, LSTM, and GRU are considered as candidates in client to capture latent features from the local data in practice.

In some embodiments, the server consists of three coordinated networks, a global feature extractor, a global probabilistic estimator and a discriminator.

In some embodiments, the network execution process steps for each iteration are forward propagation, model aggregation, backward propagation and model dispatch.

In some embodiments, the local latent features are extracted using a local feature extractor in forward propagation step.

In some embodiments, the probabilistic forecast is produced by decoding the local latent features via the local probabilistic estimator in forward propagation step.

In some embodiments, the discriminator in the server attempts to support the local feature extractors in identifying the domain invariant features by classifying the domain label of the local features in forward propagation step.

In some embodiments, the global feature extractor and probabilistic estimator in the server aggregate the knowledge of local models by taking the average values respectively.

In some embodiments, the parameters of networks serving the local feature extractors and local probabilistic estimators are updated via the algorithm in backward propagation step according to the combined loss of the probabilistic forecast and predicted domain label.

In some embodiments, the local feature extractors and probabilistic estimators take the value dispatched from the server.

In some embodiments, the local feature extractor is trained with a combined loss.

In some embodiments, the discriminator is trained using the features generated by feature extractors from different domains to maximize the log likelihood that the forecast label equals domain label.

In some embodiments, the discriminator attempts to distinguish the domain label of the local features.

Exemplary embodiments of the invention therefore provide an advanced domain invariant feature learning embedded federated learning (DIFL) framework, which consists of multiple client-side networks located locally in renewable power plants and a global network hosted in the cloud-based server. Each client hosts a network based local feature extractor and a network based probabilistic forecaster via decoding extracted features. Two networks are adapted by considering a domain invariant feature extractor and a global probabilistic forecaster dispatched from the server side as the backbones. The server-side maintains the global version of the feature extractor and probabilistic forecaster as well as develops a discriminator network to conduct the following two-stage process: 1) aggregating received local models to develop the global feature extractor and probabilistic forecaster; 2) training global feature extractor with a discriminator to help local feature extractors adapted from the global one gain with stronger robustness in local latent feature engineering.

This invention is not limited to use in long-term probabilistic renewable power sequence forecasting because of its privacy-preserving features and prediction performances.

### BRIEF DESCRIPTION OF FIGURES

The foregoing and further features of the present invention will be apparent from the following description of embodiments which are provided by way of example only in connection with the accompanying figure(s), of which:

FIG. 1 illustrates the forecasting process of classical RPF and privacy preserving RPF.

FIG. 2 is an illustration of the DIFL method according to a first embodiment of the invention.

FIG. 3 illustrates the local probabilistic estimator.

FIG. 4 shows the training and testing of Client i.

FIG. 5 shows randomly selected periods of the prediction intervals of DIFL on the WPD.

FIG. 6 shows randomly selected periods of the prediction intervals of DIFL on the SPD.

FIG. 7 illustrates the analyses of relationships between PICP and PINAW.

FIG. 8 shows the structure of an exemplary information handling apparatus that can be used to implement the methods as described above.

### DETAILED DESCRIPTION

In an exemplary embodiment of the invention, there is provided an advanced DIFL framework to coordinate the development of a system of deep network-based models serving as multiple clients and one server. In DIFL, each client, which serves each local renewable power plant, maps its raw data input into latent features via a local feature extractor and generates power output sequence probabilistic forecasts via a locally hosted forecasting model. The cloud-hosted server first aggregates the knowledge from models of clients and next dispatches the aggregated model back to each client for facilitating each local feature extractor to identify domain-invariant features via interacting with a server-side discriminator. Therefore, only desensitized data, such as parameters of the models, are allowed to be transmitted among end users for preserving local data privacy of power plants. To verify the advantages of the DIFL, a preliminary exploration of its theoretical property is first conducted. Next, computational studies are performed to benchmark the DIFL against famous baselines based on datasets collected from commercial renewable power plants. Results further confirm that, in terms of the averaged performance, the DIFL consistently realizes improvements against all benchmarks based on both real wind farm and solar power plant datasets.

TABLE I
A Comparison of Key Developments in Recent Data-driven RPF Studies.

| Studies | Renewable Power Forecasting | | |
|---|---|---|---|
| Considered | Task Complexity | Data Utilization | Key Research Developments |
| Liu et al. [11] | Point forecasting, Short-term | Local SCADA data | Forecasting by autoregressive integrated |
| | | | moving average (ARIMA) model |
| Li et al. [12] | Point forecasting, Short-term | Local SCADA data | Forecasting by support vector regression |
| | | | (SVR) model |
| Yang et al. [30] | Point forecasting, Short-term | Local SCADA and | Forecasting by fusing SCADA and NWP |
| | | NWP data | features |
| Hossain et al. [31] | Point forecasting, Short-term | Local SCADA data | Forecasting by applying long short term |
| | | | memory (LSTM) |
| Khodayar et al. [4] | Point forecasting, Short-term | SCADA data of | Forecasting by using data from different |
| | | multiple sites | sites |
| Liu et al. [32] | Point forecasting, Short-term | SCADA data of | Forecasting with graph convolution |
| | | multiple sites | network (GCN)-based feature engineering |
| Severiano et al. | Point forecasting, Short-term | SCADA data of | Forecast using fuzzy time series |
| [33] | | multiple sites | |
| Men et. al [24] | Probabilistic distribution | Local SCADA data | Forecasting by MDN model |
| | forecasting, Short-term | | |
| Yang et. al [25] | Probabilistic distribution | Local SCADA data | Forecasting model development with |
| | forecasting, Short-term | | incorporating adversarial learning |
| Brusaferri et. al | Probabilistic distribution | Local SCADA data | Forecasting by developing an improved |
| [26] | forecasting, Short-term | | MDN model |
| Zheng et. al [28] | Probabilistic distribution | Local SCADA data | Forecasting by improved mixture models |
| | forecasting, Short-term | | |
| Wan et. al [34] | Probabilistic interval | Local SCADA data | Forecasting based on extreme learning |
| | forecasting, Short-term | | machine (ELM) |
| Mesa-Jiménez et | Point forecasting, Long-term | Simulated local | Simulation-based forecasting via Markov |
| al. [35] | | SCADA data | Chain Monte Carlo (MCMC) |
| Ahmadi et al. [36] | Point forecasting, Long-term | Local SCADA data | Forecasting by applying the tree-based |
| | | | model |
| Goncalves et al. | Point forecasting, Short-term, | SCADA data of | Incorporate the FL paradigm for |
| [37] | Privacy-preserving | multiple sites | forecasting |
| Li et al. [38] | Point forecasting, Short-term, | SCADA data of | Incorporate the FL paradigm for |
| | Privacy-preserving | multiple sites | forecasting |
| Zhang et al. [39] | Probabilistic forecasting, Day- | SCADA and NWP | Jointly using SCADA and NWP data in |
| | ahead | data of multiple | probabilistic forecast |
| | | sites | |
| Zhang et al. [40] | Point forecasting, Long-term. | SCADA data of | Forecasting based on distributed learning |
| | | multiple sites | |
| Wang et al. [41] | Point forecasting, Short-term, | SCADA data of | Incorporating deep reinforcement learning |
| | Privacy-preserving | multiple sites | and FL paradigm for forecasting |
| Alshardan et al. | Point forecasting, Short-term, | SCADA data of | Incorporate the FL paradigm for |
| [42] | Privacy-preserving | multiple sites | forecasting |
| This work | Probabilistic distribution | SCADA and NWP | Forecasting via incorporating domain- |
| | forecasting, Day-ahead, | data of multiple | invariant feature learning and vertical FL |
| | Sequence forecasting, | sites | |
| | Privacy-preserving | | |

To address the more challenging task, the DRPSF with privacy preserving, the advanced DIFL framework consists of multiple client-side networks located locally in renewable power plants and a global network hosted in the cloud-based server. Each client hosts a network based local feature extractor and a network based probabilistic forecaster via decoding extracted features. Two networks are adapted by considering a domain invariant feature extractor and a global probabilistic forecaster dispatched from the server side as the backbones. The server-side maintains the global version of the feature extractor and probabilistic forecaster as well as develops a discriminator network to conduct the following two-stage process: 1) aggregating received local models to develop the global feature extractor and probabilistic forecaster; 2) training global feature extractor with a discriminator to help local feature extractors adapted from the global one gain with stronger robustness in local latent feature engineering. Iterative interactions between clients and server mainly refer to the transmission of local models to the server and the dispatch of updated global models back to every client. DIFL enables knowledge transfer among the clients without breaching local data as the information transmitted between clients and the server only includes latent features and model parameters. DIFL also alleviates the burden of the server by distributing computational loads across the clients and server. To verify the advantages of DIFL, it is mathematically shown that the forecasting error in the target domain can be bounded by a combination of modeling quality in the source domain and the divergence between source and target domain. Furthermore, a comprehensive computational study based on datasets of commercial renewable power plants is conducted via benchmarking DIFL against famous baselines. Results show that the DIFL yields better performances on most cases compared with classical RPF frameworks trained with full data. The contribution of the embodiment to prior art is four-fold:
Privacy-preserving with more advanced RPF task: A pioneering study of a more advanced RPF task, the probabilistic DRPSF of multiple plants with privacy preserving, is presented. As reported in Table 1, studies of RPF models with privacy-preserving [37-42] mainly considered deterministic RPF problems and short-term forecasting tasks.
Fused DRPSF under privacy-preserving: This work investigates a “server-client” based system coordinating network-based models for simultaneously forecasting day-ahead power generation sequences of wind turbines and solar panels in multiple renewable power plants. As reported in Table 1, most RPF with privacy preserving studies [37-42] discussed wind and solar power forecasting tasks separately.
New modeling pipeline with domain invariant learning: A novel DIFL based method is developed to enable more effective probabilistic RPF modeling for each renewable power plant via leveraging the knowledge gained from the population-level without breaching the local data privacy. Different from previous FL studies [37-42, 49], a discriminator is developed in the server side to approximate the upper bound of differences among local data feature spaces and facilitate local feature extractors to obtain domain-invariant features. The DIFL method preserves data privacy by transmitting only the latent features and model parameters between clients and server. To best of knowledge of the inventors, DIFL is a pioneering work that integrates invariant feature engineering from different domains in privacy preserving tasks.
Better modeling performance: DIFL leverages the population knowledge with privacy preserving to develop strong probabilistic RPF models for each renewable power plant according to comprehensive computational experiments conducted in this work. Meanwhile, an upper bound of the forecasting error of DIFL is also derived via a mathematical analysis.

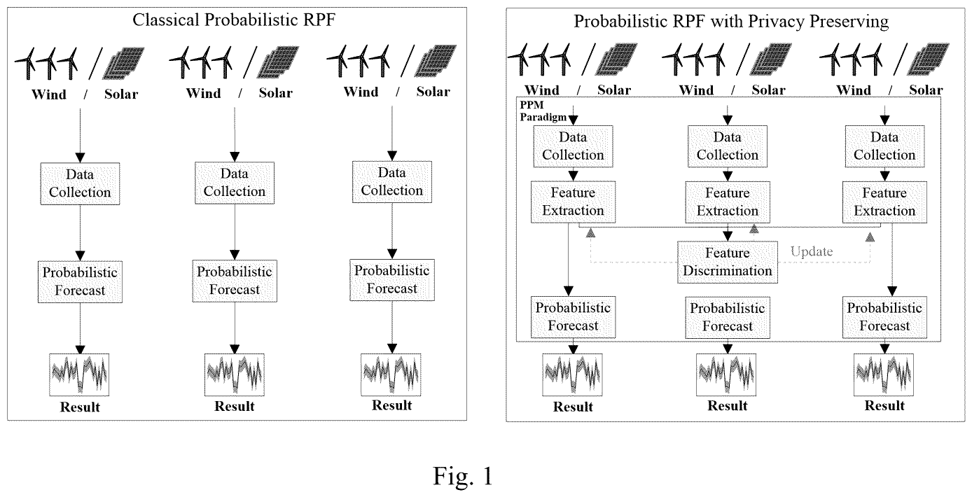

In the next section, the classical formulation of the day-ahead probabilistic RPF problem using only data of one power plant is firstly briefed, which is illustrated in the left part of FIG. 1. Next, the formulation considered in this work leveraging data from multiple sites with privacy-preserving in RPF modeling is introduced, as illustrated in the right part of FIG. 1.

Let x^{hist} ∈ [symbol] ^{N×T×Mhist} denote the M-dimensional multivariate time series including the historical power output collected from N different wind or solar power plants for T time-steps, xᵢ ∈ [symbol] ^{T×Mhist} denote the input record collected from the i^{th} power plant (i=1, 2, . . . , N), The classical probabilistic RPF task aims to develop a data-driven model fᵢ(·) to estimate the probabilistic forecast P(xᵢ) of one day ahead power output, which can be described quantiles, lower and upper bounds, or even distributions. In practice, P(xᵢ) is most commonly described by mixture conditional density functions p(y|xᵢ) as the left part of FIG. 1 shows. The formulation is provided in (1) and (2).

$$p ( y \vert {x}_{i} ) = {\sum }_{k = 1}^{L} {w}_{i , k} B ( {x}_{i} ; {θ}_{i} ) \qquad ( 1 )$$

$${w}_{i , k} , {θ}_{i} = {f}_{i} ( {x}_{i} ) \qquad ( 2 )$$

where Z is the number of components in the mixture model, w_{i,k} satisfies Eq. (3), and B (xᵢ; θ) is a distribution with parameter θ. In practice, beta distribution Beta(x; α, β) described in Eq. (4) is commonly selected as a component in the mixture model.

$${\sum }_{k = 1}^{L} {w}_{i , k} = 1 ∀ i = 1 , 2 , … , N \qquad ( 3 )$$

$$Beta ( x : α , β ) = \frac{Γ ( α + β )}{Γ ( α ) Γ ( β )} {{x}^{α - 1} ( 1 - x )}^{β - 1} \qquad ( 4 )$$

$$where Γ ( x ) = {\int }_{0}^{∞} {t}^{x - 1} {e}^{- t}$$

dt is the gamma function. To select the best parameters wᵢ, αᵢ and βᵢ in the i^{th} power plant, MLE method is typically adopted to maximize the log likelihood of the actual power output yᵢ of the dataset Dᵢ based on (5).

$${w}_{i}^{*} , {α}_{i}^{*} , {β}_{i}^{*} = arg {max}_{w , α , β} {𝔼}_{( {x}_{i} , {y}_{i} ) \sim {𝒟}_{i}} {{\prod }^{{T}^{′}}}_{j = 1} log {p}_{j} ( y \vert {x}_{i} ) \qquad ( 5 )$$

In this section, an extension of the classical RPF modeling with proposing a privacy preserving modeling scheme is presented to enable an efficient utilization of the information in both NWP and historical data x=[x^{NWP}, x^{hist}]∈ [symbol] ^{N×(t′×MNWP+T×Mhist)} from N power plants as the right part of FIG. 1 shows. To leverage the information contained in data from different power plants with privacy-preserving, a privacy preserving modeling (PPM) paradigm is designed. In the PPM paradigm, the data-driven model is first decomposed into two modules, the feature extractor gᵢ(·) for deriving the local latent features zᵢ and the probabilistic estimator fᵢ(·) for providing the distribution of the power generation of day ahead probabilistic renewable power generation sequence p_{i,1}(y|xᵢ), . . . , p_{i,T′}(y|xᵢ), where T′ is the length of the forecast sequence, as described in (6)-8)

$${p}_{i , j} ( y \vert {x}_{i} ) = {\sum }_{k = 1}^{L} {w}_{i , j , k} B ( {x}_{i} ; {θ}_{i} ) , ∀ j ∈ [ 1 , 2 , … , {T}^{′} ] \qquad ( 6 )$$

$${w}_{i , j , k} , {θ}_{i , j} = {f}_{i , j} ( {z}_{i} ) \qquad ( 7 )$$

$${z}_{i} = {g}_{i} ( {x}_{i} ) \qquad ( 8 )$$

This modeling process enables the transmission of desensitized information including latent features zᵢ and modules fᵢ(·), gᵢ(·) to enhance the performance through the following two techniques.

Firstly, to leverage the knowledge learned from different clients, a global feature extractor g̅(·) and a global probabilistic estimator f̅(·) are designed to aggregate the knowledge from g₁(·), g₂(·), . . . , g_{N}(·) and f₁(·), f₂(·), . . . , f_{N}(·) via (9) and (10) respectively. The aggregated models are then dispatched back to each client.

$$\overline{g} = \frac{1}{N} {\sum }_{i = 1}^{N} {g}_{i} \qquad ( 9 )$$

$$\overline{f} = \frac{1}{N} {\sum }_{i = 1}^{N} {f}_{i} \qquad ( 10 )$$

Secondly, to help the feature extractors to produce domain invariant features, a discriminator d (·) is designed to predict the domain label i ∈ {1, 2, . . . , N} of local features zᵢ.

Based on such a modeling setup, the local models are able to consider knowledge from different sources and improve the forecasting performance. Meanwhile, it is also discovered that there exists a performance bound for the local forecasting based on incorporating the knowledge from other sources. Let [symbol] _{T} denote the data distribution from the target domain i and D_{S} denote the data distribution from the source domain, which is a concatenation of all domains. Next, a mathematical proof of the guaranteed performance of the forecast error in D_{T} is provided, which is bounded by a combination of modeling quality in D_{S} and the divergence between in D_{S} and in D_{T}.

Definition 1. The probabilistic errors [symbol] (P), [symbol] (P) of distribution P according to D_{S} and D_{T} are defined as (11) and (12), respectively:

$${ϵ}_{{𝒟}_{S}} ( P ) = {Pr}_{( x , y ) \sim {𝒟}_{S}} ( y ≁ P ( x ) ) = {{\prod }^{{T}^{′}}}_{j = 1} 1 - {p}_{i , j} ( {y}^{( j )} \vert x ) \qquad ( 11 )$$

$${ϵ}_{{𝒟}_{T}} ( P ) = {Pr}_{( x , y ) \sim {𝒟}_{T}} ( y ≁ P ( x ) ) = {{\prod }^{{T}^{′}}}_{j = 1} 1 - {p}_{i , j} ( {y}^{( j )} \vert x ) \qquad ( 12 )$$

where y^{(j)} denote the actual power output of j time steps ahead

Definition 2. Let Pₕ(x) be a hypothesis distribution. The probability that a hypothesis Pₕ disagrees with another distribution P according to D is defined as (13):

$${ϵ}_{𝒟} ( P , {P}_{h} ) = {𝔼}_{( x , y ) \sim 𝒟} [ Pr ( ( y ≁ P ( x ) ) ⊕ ( y ≁ {P}_{h} ( x ) ) ) ] \qquad ( 13 )$$

where ⊕ represents the xor function, A⊕B=(¬A ∩ B) ∪ (A ∩ ¬B).

Definition 3. Given a domain [symbol] with [symbol] and D′ distributions over [symbol] , let [symbol] be a hypothesis class on [symbol] . The divergence of D and D′ can be defined as (14):

$${d}_{𝒦} ( 𝒟 , {𝒟}^{′} ) = 2 {sup}_{P , {P}^{′} ∈ 𝒦} \vert {ϵ}_{𝒟} ( P , {P}^{′} ) - {ϵ}_{𝒟 ′} ( P , {P}^{′} ) \vert \qquad ( 14 )$$

Definition 4. The ideal joint hypothesis P* of D_{S} and D_{T} is the hypothesis which minimizes the combined error as (15):

$${P}^{*} = arg min {ϵ}_{{𝒟}_{S}} ( P ) + {ϵ}_{{𝒟}_{T}} ( P ) \qquad ( 15 )$$

Lemma 1. For any hypothesis P and P′ on domain D,

$${ϵ}_{𝒟} ( P ) \leq {ϵ}_{𝒟} ( {P}^{′} ) + {ϵ}_{𝒟} ( P , {P}^{′} ) \qquad ( 16 )$$

$${ϵ}_{𝒟} ( P , {P}^{′} ) \leq {ϵ}_{𝒟} ( P ) + {ϵ}_{𝒟} ( {P}^{′} ) \qquad ( 17 )$$

Proof: According to probability inequalities, when (x, y)˜D,

$$\begin{matrix}Pr ( y \sim {P}^{′} ( x ) ) \leq Pr ( y \sim {P}^{′} ( x ) ⋃ y \sim P ( x ) ) \\ \leq Pr ( y \sim P ( x ) ) + Pr ( y ≁ P ( x ) ⋂ y \sim {P}^{′} ( x ) ) \\ \leq Pr ( y \sim P ( x ) ) + Pr [ ( y ≁ P ( x ) ⊕ y ≁ {P}^{′} ( x ) ) \\ = Pr ( y \sim P ( x ) ) + {ϵ}_{𝒟} ( P , {P}^{′} )\end{matrix}$$

Hence, 1-Pr (y˜P(x))≤1−Pr(y˜P′(x))+ [symbol] (P, P′), and the proof of (16) is complete. Meanwhile, (17) can be proved by the following inequalities

$${ϵ}_{𝒟} ( P , {P}^{′} ) = Pr ( y ≁ P ( x ) ⊕ y ≁ {P}^{′} ( x ) ) \leq Pr ( y ≁ P ( x ) ⋂ y ∼ {P}^{′} ( x ) ) + Pr ( y ∼ P ( x ) ⋂ y ≁ {P}^{′} ( x ) ) \leq Pr ( y ≁ P ( x ) ) + Pr ( y ≁ {P}^{′} ( x ) )$$

Proposition 1 [symbol] (P)≤ [symbol] (P)+▴/2 dₓ( [symbol] _{S}, [symbol] _{T})+C, where C is a constant.

Proof: According to Lemma 1 and Definition 3,

$${ϵ}_{{𝒟}_{T}} ( P ) \leq {ϵ}_{{𝒟}_{T}} ( {P}^{*} ) + {ϵ}_{{𝒟}_{T}} ( P , {P}^{*} ) \leq {ϵ}_{{𝒟}_{T}} ( {P}^{*} ) + {ϵ}_{{𝒟}_{S}} ( P , {P}^{*} ) + \vert {ϵ}_{{𝒟}_{T}} ( P , {P}^{*} ) - {ϵ}_{{𝒟}_{S}} ( P , {P}^{*} ) \vert \leq {ϵ}_{{𝒟}_{T}} ( {P}^{*} ) + {ϵ}_{{𝒟}_{S}} ( P , {P}^{*} ) + \frac{1}{2} {d}_{ℋ} ( {𝒟}_{S} , {𝒟}_{T} ) \leq {ϵ}_{{𝒟}_{S}} ( P ) + \frac{1}{2} {d}_{ℋ} ( {𝒟}_{S} , {𝒟}_{T} ) + {ϵ}_{{𝒟}_{S}} ( {P}^{*} ) + {ϵ}_{{𝒟}_{T}} ( {P}^{*} )$$

Hence, C= [symbol] (P*)+ [symbol] (P*) is the combined error of the ideal hypothesis P*. To minimize ϵ_{D}_{_{T}}(P), ϵ_{D}_{_{S}}(P) should be minimized by probabilistic estimator g(·) and d_{H}(D_{S}, D_{T}) should be minimized by feature extractor f(·) which produce domain invariant features. Meanwhile, to ensure Proposition 1 always holds, the hypothesis class H_{d} generated by the discriminator d(·) should be rich enough and satisfy [symbol] ⊆ [symbol] _{d}.

$$Denote I ( x ) = \{ \begin{matrix}0 , & if y ≁ P ( x ) \\ 1 , & if y ∼ P ( x )\end{matrix} , and one has :$$

$$\begin{matrix}{d}_{ℋ} ( {𝒟}_{S} , {𝒟}_{T} ) = 2 {sup}_{{𝒟}_{S} , {𝒟}_{T} ∈ ℋ} \vert {Pr}_{( x , y ) ∼ {𝒟}_{S}} ( y ≁ P ( x ) ) - {Pr}_{( x , y ) ∼ {𝒟}_{T}} ( y ≁ P ( x ) ) \vert \\ \leq 2 {sup}_{{𝒟}_{S} , {𝒟}_{T} ∈ {ℋ}_{d}} \vert {Pr}_{( x , y ) ∼ {𝒟}_{S}} ( y ≁ P ( x ) ) - {Pr}_{( x , y ) ∼ {𝒟}_{T}} ( y ≁ P ( x ) ) \vert \\ = 2 {sup}_{{𝒟}_{S} , {𝒟}_{T} ∈ {ℋ}_{d}} \vert {Pr}_{( x , y ) ∼ {𝒟}_{S}} ( y ≁ P ( x ) ) + {Pr}_{( x , y ) ∼ {𝒟}_{T}} ( y ∼ P ( x ) ) - 1 \vert \\ = 2 {sup}_{{𝒟}_{S} , {𝒟}_{T} ∈ {ℋ}_{d}} \vert {Pr}_{( x , y ) ∼ {𝒟}_{S}} ( I ( x ) = 0 ) + {Pr}_{( x , y ) ∼ {𝒟}_{T}} ( I ( x ) = 1 ) - 1 \vert\end{matrix}$$

Hence, the upper bound of [symbol] ( [symbol] _{S}, [symbol] _{T}) can be obtained with the discriminator d(·) with sufficient complexity which judges [symbol] _{S} as 0 and [symbol] _{T} as 1. In this case, one can obtain a better performance as Proposition 1 indicates.

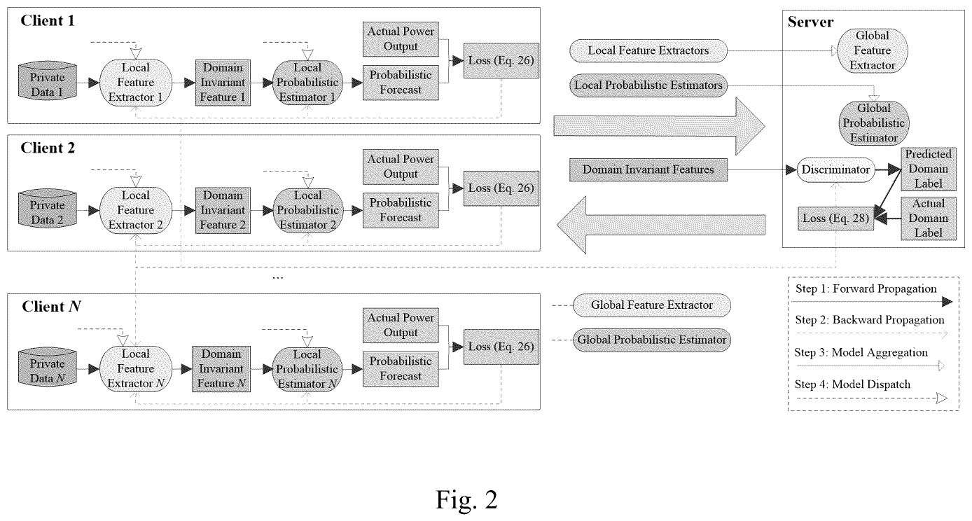

The DIFL framework develops a system of network-based forecasting models located in clients and the server, which are iteratively executed via I training iterations. These iterations will be described in detail below. In each iteration, the following four steps (Step 1-4) are applied, as shown in FIG. 2.

Step 1 (Forward Propagation): Based on local data of i^{th} renewable power plant (client i), xᵢ, local latent features zᵢ are extracted using a local feature extractor gᵢ(·) via (8). Next, probabilistic forecast P is produced by decoding zᵢ via the local probabilistic estimator fᵢ(·) as described in (6) and (7). The discriminator d(·) in the server attempts to support the local feature extractors in identifying the domain invariant features by classifying the domain label of the local features.

Step 2 (Model Aggregation): The global feature extractor g̅(·) and probabilistic estimator f̅(·) in the server aggregate the knowledge of local models by taking the average values of g₁(·), g₂(·), . . . , g_{N}(·) and f₁(·), f₂(·), . . . , f_{N}(·), respectively, via (9) and (10).

Step 3 (Backward Propagation): The parameters of networks serving the local feature extractors and local probabilistic estimators are updated via the backward propagation algorithm according to the combined loss of the probabilistic forecast and predicted domain label (Eq. (28)).

Step 4 (Model Dispatch): The local feature extractors, g₁(·), g₂(·), . . . , g_{N}(·), and probabilistic estimators, f₁(·), f₂(·), . . . , f_{N}(·), take the value of g̅(·) and f̅(·) dispatched from the server.

Via the above four steps, the clients can transfer knowledge without breaching data privacy. Next, the structures of the clients and server are explained below.

As shown in the left part of FIG. 2, N separated clients are designed to process private data x₁, x₂, . . . , x_{N} and provide domain invariant features z₁, z₂, . . . , z_{N} and probabilistic forecasts P₁, P₂, . . . , P_{N}. Each client i consists of two coordinated networks, a local feature extractor gᵢ(·) and a local probabilistic estimator fᵢ(·).

In each training iteration m, the local feature extractor

$${g}_{i}^{m}$$

(·) transforms the private input xᵢ to local feature

$${z}_{i}^{m}$$

via (18).

$${z}_{i}^{m} = {g}_{i}^{m} ( {x}_{i} ) \qquad ( 18 )$$

In practice, to capture latent features from the local data, four widely applied deep networks, the DNN, CNN, LSTM, and GRU, are considered as candidates for

$${g}_{i}^{m}$$

(·).

Moreover, the local probabilistic estimator

$${f}_{i}^{m}$$

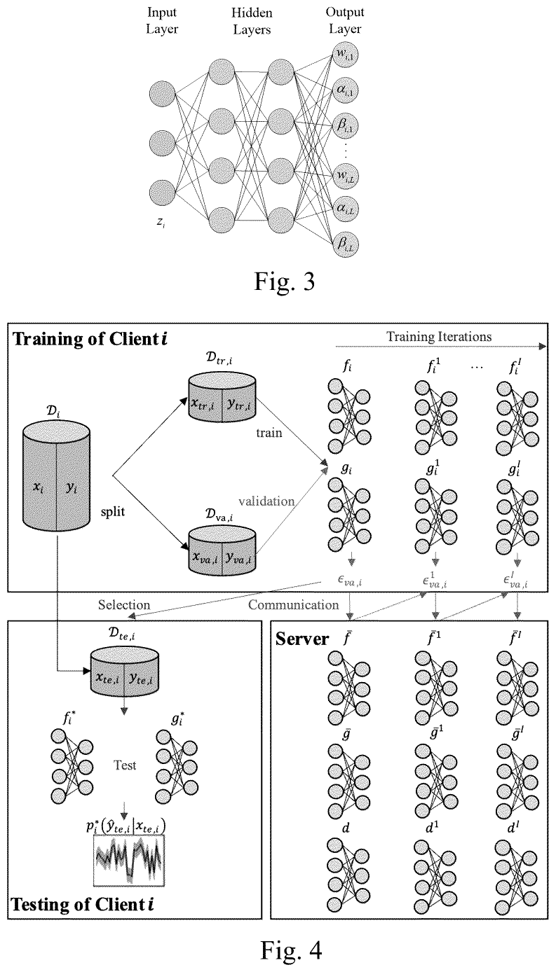

(·) is the mixture density network, which is a fully connected neural network shown in FIG. 3 outputting the parameters of the components and providing the forecast

$${p}_{i}^{m}$$

based on the local feature

$${z}_{i}^{m}$$

as described by (19) and (20).

$${p}_{i , j}^{m} ( y \vert {x}_{i} ) = {\sum }_{k = 1}^{L} {w}_{i , j , k}^{m} B ( {x}_{i} ; {θ}_{i}^{m} ) , ∀ j ∈ [ 1 , 2 , ... , {T}^{′} ] \qquad ( 19 )$$

$${w}_{i , j , k}^{m} , {θ}_{i}^{m} = {f}_{i}^{m} ( {z}_{i}^{m} ) \qquad ( 20 )$$

$$where {w}_{i , j , k}^{m}$$

satisfies (3) for each m=1, 2, . . . , I, and B (xᵢ; θ) is a distribution with parameter θ. In practice, the beta distribution is commonly selected as a component in the mixture model.

As shown in the right part of FIG. 2, the server consists of three coordinated networks, a global feature extractor g̅(·), a global probabilistic estimator f̅(·), and a discriminator d(·).

In the m^{th} learning iteration, g̅^{m}(·) and f̅^{m}(·) collect and aggregate the parameters of g₁, g₂, . . . , g_{N} and f₁, f₂, . . . , f_{N}, via (21) and (22) respectively.

$${\overline{g}}^{m} = \frac{1}{N} {\sum }_{i = 1}^{N} {g}_{i}^{m} \qquad ( 21 )$$

$${\overline{f}}^{m} = \frac{1}{N} {\sum }_{i = 1}^{N} {f}_{i}^{m} \qquad ( 22 )$$

Meanwhile, the discriminator d(·) attempts to distinguish the domain label of the local features

$${z}_{i}^{m}$$

via (23).

$${l}_{i}^{m} = d ( {z}_{i}^{m} ) , ∀ i = 1 , 2 , ... , N \qquad ( 23 )$$

At the end of the m^{th} iteration, the server dispatches g̅^{m}(·) and f̅^{m}(·) to the clients, which will serve as the local models of the m+1^{th} iteration as shown in (24) and (25).

$${g}_{i}^{m + 1} = {\overline{g}}^{m} , ∀ i = 1 , 2 , ... , N \qquad ( 24 )$$

$${f}_{i}^{m + 1} = {\overline{f}}^{m} , ∀ i = 1 , 2 , ... , N \qquad ( 25 )$$

As FIG. 4 shows, the DIFL method is trained with I training iterations to obtain the best parameters of the local and global models. In m^{th} iteration, m=1, 2, . . . , I, the local probabilistic estimator

$${f}_{i}^{m}$$

(·) in client i is trained using the local training data [symbol] _{tr,i} via (26) to maximize the log likelihood of the probabilistic forecast

$${p}_{i}^{m}$$

(·).

$${f}_{i}^{m} = arg {max}_{f} {𝔼}_{( {x}_{i} , {y}_{i} ) \sim {𝒟}_{tr , i}} log {\prod }_{j = 1}^{{T}^{′}} {p}_{i , j}^{m} ( y \vert {x}_{i} ) \qquad ( 26 )$$

In addition, the discriminator d^{m}(·) is trained using the features

$${z}_{1}^{m} , {z}_{2}^{m} , … , {z}_{N}^{m}$$

generated by feature extractors

$${g}_{1}^{m} ( \cdot ) , {g}_{2}^{m} ( \cdot ) , … , {g}_{N}^{m} ( \cdot )$$

from different domains via (27) to maximize the log likelihood that the forecast label

$${l}_{i}^{m}$$

equals domain label i.

$${d}^{m} = arg {max}_{d} {\sum }_{i = 1}^{N} {𝔼}_{( {x}_{i} , {y}_{i} ) \sim {𝒟}_{tr , i}} log Pr ( {l}_{i}^{m} = i ) \qquad ( 27 )$$

Besides, the local feature extractor

$${g}_{i}^{k}$$

(·) is trained with a combined loss of (26) and (27), via (28).

$${g}_{i}^{m} = arg {max}_{f} {𝔼}_{( {x}_{i} , {y}_{i} ) \sim {𝒟}_{tr , i}} {\prod }_{j = 1}^{{T}^{′}} log {p}_{i}^{m} ( {y}^{( j )} \vert {x}_{i} ) + {\sum }_{i = 1}^{N} {𝔼}_{( {x}_{i} , {y}_{i} ) \sim {𝒟}_{tr , i}} log Pr ( {l}_{i}^{k} = i ) \qquad ( 28 )$$

Finally, the best local models

$${f}_{i}^{*} , {g}_{i}^{*}$$

are selected from I models

$${f}_{i}^{( 1 )} ( \cdot ) , {f}_{i}^{( 2 )} ( \cdot ) , … , {f}_{i}^{( I )} ( \cdot ) and {g}_{i}^{( 1 )} ( \cdot ) , {g}_{i}^{( 2 )} ( \cdot ) , … , {g}_{i}^{( I )} ( \cdot )$$

respectively according to the performance of the validation set as defined in (29).

$$ϵ = {\sum }_{i = 1}^{N} {( {x}_{i} , {y}_{i} ) \sim {𝒟}_{tr , i}}_{} {\prod }_{j = 1}^{{T}^{′}} log {p}_{i , j}^{m} ( {y}^{( j )} \vert {x}_{i} ) \qquad ( 29 )$$

Algorithm 1 Training process for DIFL

```
Input: Training dataset [symbol] _{tr,1}, [symbol] _{tr,2}, ... , [symbol] _{tr,N} and validation dataset
Parameters: Initial feature extractors g₁(·), g₂(·), ... , g_{N}(·), initial probabilistic
estimators f₁(·), f₂(·), ... , f_{N}(·), initial discriminator d(·), number of iteration I, and
$Output : Optimal feature extractors {g}_{1}^{*} ( \cdot ) , {g}_{2}^{*} ( \cdot ) , ... , {g}_{N}^{*} ( \cdot ) , and optimal probabilistic$
Server executes:
  $1. {\overline{g}}^{0} ( \cdot ) , {\overline{f}}^{0} ( \cdot ) ← \frac{1}{\text{?}} {\sum }_{i = 1}^{N} {g}_{i} ( \cdot ) \text{?} \frac{1}{\text{?}} {\sum }_{i = 1}^{N} {g}_{i} ( \cdot )$
  $2. {d}^{0} ( \cdot ) , {ϵ}_{i}^{*} ← d ( \cdot ) , ∞$
  3. For m ← 1, 2, ... , I do
  4. For i ← 1, 2. ... , N in parallel do // Step 1
  $5. {z}_{i}^{m} , {g}_{i}^{m} , {f}_{i}^{m} , {ϵ}_{tr , i}^{m} , {ϵ}_{va , i}^{m} ← ClientUpdate ( i , k , {\overline{g}}^{m - 1} , {\overline{f}}^{m - 1} )$
  $6. {l}_{i}^{m} = {d}^{m - 1} ( {z}_{i}^{m} )$
  $7. If {ϵ}_{va , i}^{m} < {ϵ}_{i}^{*} then$
  $8. {ϵ}_{i}^{*} , {g}_{i}^{*} , {f}_{i}^{*} ← {ϵ}_{va , i}^{m} , {g}_{i}^{m} , {f}_{i}^{m}$
  9. End If
10. End For
$11. {\overline{g}}^{m} , {\overline{f}}^{m} , {ϵ}^{m} ← \frac{1}{\text{?}} {\sum }_{i = 1}^{N} {g}_{i}^{m} \text{?} \frac{1}{\text{?}} {\sum }_{i = 1}^{N} {g}_{i}^{m} , {\sum }_{i = 1}^{N} {ϵ}_{va , i}^{m} / / Step 2$
$12. e = {\sum }_{i = 1}^{N} log Pr ( {l}_{i}^{m} = i )$
13. d^{k} = arg max e
14. For i + 1, 2, ... , N in parallel do // Step 3
15. ClientBackPropagate(i, m, e. ϵ_{tr,i})
16. End For
17. End For
$18. Return {g}_{1}^{*} ( \cdot ) , ... , {g}_{N}^{*} ( \cdot ) , {f}_{1}^{*} ( \cdot ) , ... , {f}_{N}^{*} ( \cdot )$
$ClientUpdate ( i , m , {\overline{g}}^{m - 1} , {\overline{f}}^{m - 1} ) :$
$1. {g}_{i}^{m} , {f}_{i}^{m} ← {\overline{g}}^{m - 1} , {\overline{f}}^{m - 1} / / Step 4$
2. (x,_{tr,i}, y_{tr,i}). (x_{va,i}, y_{va,i}) ← [symbol] _{tr,i}, [symbol] _{va,i}
$3. {z}_{tr , i}^{m} , {z}_{va , i}^{m} ← {g}_{i}^{k} ( {x}_{tr , i} ) , {g}_{i}^{k} ( {x}_{va , i} )$
$4. {w}_{i , j , k}^{m} , {θ}_{i}^{m} ← {f}_{i}^{m} ( {z}_{tr , i}^{m} )$
$5. {p}_{i , j}^{m} ( y \vert {x}_{i} ) = {\sum }_{k = 1}^{L} {w}_{i , j , k}^{m} B ( {x}_{i} ; {θ}_{i}^{m} ) , ∀ j ∈ [ 1 , 2 , ... , {T}^{′} ]$
$6. \text{?} , \text{?} ← \text{?} ( \text{?} \vert \text{?} ) , \text{?} ( \text{?} \vert \text{?} )$
$7. Return {z}_{tr , i}^{m} , {g}_{i}^{m} , {f}_{i}^{m} , {ϵ}_{tr , i} , {ϵ}_{va , i}$
ClientBackPropagate(i, m, e, ϵᵢ):
$1. {g}_{i}^{m} ← arg \text{?} {ϵ}_{i} + e$
$2. {f}_{i}^{m} ← arg {max}_{f} {ϵ}_{i}$
$\text{?} \text{indicates text missing or illegible when filed}$
```

After training the local feature extractors and probabilistic estimators, the DIFL framework can be tested on the test set (x_{te,i}, y_{te,i})˜ [symbol] _{te,i}(i=1, 2, . . . , N) using the system of developed models to obtain the prediction pᵢ*(y|xᵢ) via (30) (32).

$${z}_{i} = {g}_{i}^{*} ( {x}_{te , i} ) , ∀ i = 1 , 2 , … , N \qquad ( 30 )$$

$${w}_{i , j , k}^{*} , {θ}_{i , j , k}^{*} = {f}_{i}^{*} ( {z}_{i} ) \qquad ( 31 )$$

$${p}_{i , j}^{*} ( y \vert {x}_{te , i} ) = {\sum }_{k = 1}^{L} {w}_{i , j , k}^{*} B ( {x}_{te , i} ; {θ}_{i , j , k}^{*} ) \qquad ( 32 )$$

The method is tested on two datasets, WFD and SPD, which are collected from 6 commercial wind farms and 6 grid-connected solar power plants in Mainland China, respectively. Both datasets include 2 years of historical power output measurements and numerical weather predictions, such as the temperatures, air pressure, heat flux, radiant flux, precipitation, wind speed and wind direction, from January 2019 to December 2020 with a 10-min sampling interval. The processed data are split into the training sets, validation sets, and test sets, which contains 80%, 10%, and 10% of total data points respectively.

The DIFL framework is implemented using Pytorch with GPU acceleration. The training is performed on a single NVIDIA GTX 2080Ti GPU. The performance is evaluated via widely adopted metrics, the prediction interval coverage probability (PICP), prediction interval normalized average width (PINAW), average coverage error (ACE), continuous ranked probability score (CRPS), normalized root mean square error (NRMSE), and normalized mean absolute error (NMAE) as expressed in (33)-(38):

$$PICP = \frac{1}{{N}_{s}} {\sum }_{i = 1}^{{N}_{s}} I ( {L}_{i} \leq {y}_{i} \leq {U}_{i} ) \qquad ( 33 )$$

$$PINAW = \frac{1}{{N}_{s}} {\sum }_{i = 1}^{{N}_{s}} \frac{\vert {U}_{i} - {L}_{i} \vert}{{y}_{max}} \qquad ( 34 )$$

$$ACE = PICP - PINC \qquad ( 35 )$$

$$CRPS = \frac{1}{{N}_{s}} {\sum }_{i = 1}^{{N}_{s}} {\int }_{0}^{1} {F}_{i} ( y ) - I ( {y}_{i}^{*} \leq y ) dy \qquad ( 36 )$$

$$NRMSE = \sqrt{\frac{1}{{N}_{s}} {\sum }_{i = 1}^{{N}_{s}} \frac{{( {y}_{i} - {\hat{y}}_{i} )}^{2}}{{y}_{max}}} \qquad ( 37 )$$

$$MAE = \frac{1}{{N}_{s}} {\sum }_{i = 1}^{{N}_{s}} \frac{\vert {y}_{i} - {\hat{y}}_{i} \vert}{{y}_{max}} \qquad ( 38 )$$

where Nₛ denotes the number of the samples, [Lᵢ, Uᵢ] denotes the prediction interval under a certain level of confidence, Fᵢ(y) denotes the estimated cumulative distribution function, ŷᵢ denote the mode of the prediction,

$${y}_{i}^{*}$$

denote the normalized actual wind power output, and PINC represents the nominal confidence of the prediction interval.

To determine high quality hyperparameter settings for training different models, the commonly applied grid search process is conducted. The candidate settings of hyperparameters considered are described in Table II. These settings are extracted via jointly considering results of preliminary trials and empirical knowledge in studying renewable power forecasting with deep learning. The validation dataset is utilized to evaluate the performance of two algorithms based on the CRPS metric.

TABLE II
Hyperparameters and their setting options.

| | | | Best setting |
|---|---|---|---|
| Models | Hyperparameters | Candidate settings | selected |
| LSTM | Training Epochs | 60, 70, 80, 90, 100 | 90 |
| | Batch size | 64, 128, 256, 512 | 128 |
| | Number of layers | 1, 2, 3, 4, 5, 6 | 2 |
| | Number of Hidden | 16, 32, 64, 128, | 256 |
| | dimensions | 256, 512 | |
| | Dropout Rate | 0.05, 0.1, 0.2 | 0.1 |
| GRU | Training Epochs | 60, 70, 80, 90, 100 | 80 |
| | Batch size | 64, 128, 256, 512 | 128 |
| | Number of layers | 1, 2, 3, 4, 5, 6 | 2 |
| | Number of Hidden | 16, 32, 64, 128, | 256 |
| | dimensions | 256, 512 | |
| | Dropout Rate | 0.05, 0.1, 0.2 | 0.1 |
| CNN | Training Epochs | 60, 70, 80, 90, 100 | 100 |
| | Batch size | 64, 128, 256, 512 | 256 |
| | Number of layers | 1, 2, 3, 4, 5, 6 | 4 |
| | Number of Hidden | 16, 32, 64, 128, | 256 |
| | dimensions | 256, 512 | |
| | Dropout Rate | 0.05, 0.1, 0.2 | 0.05 |
| DNN | Training Epochs | 60, 70, 80, 90, 100 | 80 |
| | Batch size | 64, 128, 256, 512 | 256 |
| | Number of layers | 1, 2, 3, 4, 5, 6 | 2 |
| | Number of Hidden | 16, 32, 64, 128, | 128 |
| | dimensions | 256, 512 | |
| | Dropout Rate | 0.05, 0.1, 0.2 | 0.1 |

To validate the method provided by the exemplary embodiment of the invention, benchmarks using different learning paradigms listed as follows are considered.
RPF trained with local data (RPF-local): A generic RPF learning paradigm as introduced in Section 2, which is trained using only local data.
RPF trained with full data (RPF-full): The data collected from N clients are simply merged into a global dataset, and the generic RPF learning paradigm is trained using the global dataset.
FedAvg [36]: FedAvg framework is iteratively developed based on horizontal federated learning paradigm. In each iteration, the local data x₁, x₂, . . . , x_{N} collected from N clients are used in training local models. The global model in the server aggregates the parameters of these N local models via taking the mean value. In the beginning of search iteration, the parameters of the global model are copied to each local models.

The method provided by the exemplary embodiment of the invention is first verified by presenting the performance of the DIFL paradigm and the baselines based on the CRPS, NMAE and NRMSE metrics. The results are reported in Tables III-VI. According to the left part of Table III, it is noticed that all models trained by DIFL can obtain the lowest average value in terms of CRPS based on the WFD. In addition, by first computing the CRPS improvement percentages of DIFL against RPF-local, RPF-full, and FedAvg based on each gᵢ(·) candidate while next averaging these percentages over four gᵢ(·) candidates, it can be obtained that DIFL achieves 5.49%, 10.55% and 2.72% average CRPS improvement against the RPF-local, RPF-full, and FedAvg respectively. FedAvg is the second-best paradigm which outperforms the other three candidates when LSTM, GRU, and CNN are applied to develop feature extractor gᵢ(·). When DNN is applied as g_{θ}, RPF-local is the second-best paradigm. Meanwhile, it is also noticed that, based on the WFD, different feature extractor gᵢ(·) obtain similar results. Moreover, the worst performance of DIFL, obtained by applying DNN as feature extractor gᵢ(·), is still better than the best performance of RPF-local and RPF-full. It is also slightly better than the best performance of FedAvg, which indicates that the choice of the learning paradigm is more important than the choice of the feature extractor. The best performance can be obtained by using LSTM as gᵢ(·) and DIFL as the learning paradigm. Furthermore, it is also noticed that the RPF-full cannot perform well in most scenarios, meaning that directly using all datasets from different sources cannot guarantee a better performance, which further verifies the significance of the domain invariant features extracted by the DIFL paradigm. Similarly, the CRPS value of different methods based on the SPD are shown in the right part of Table III. It is observable that DIFL outperforms other baselines, resulting in 8.17%, 22.36% and 4.02% improvements compared with RPF-local, RPF-full, FedAvg, respectively. Meanwhile, it is also noticed that the GRU outperforms other models under RPF-local, FedAvg, and the DIFL. The best performance can be obtained by using GRU as gᵢ(·) and DIFL as the learning paradigm. It is also worth noting that the performance of RPF-full is the worst among these paradigms, which indicates that simply merging the local datasets may increase the noises and impair the quality of forecasting model development.

TABLE III
CRPS of different methods.

| | | WFD | | | | | | | SPD | | | | | | |
|---|---|---|---|---|---|---|---|---|---|---|---|---|---|---|---|
| Method | gᵢ(•) | 1 | 2 | 3 | 4 | 5 | 6 | Avg | 1 | 2 | 3 | 4 | 5 | 6 | Avg |
| RPF-local | LSTM | 0. [symbol] 76 | 0.1 [symbol] 2 | 0.153 | 0.134 | 0.104 | 0. [symbol] 20 | 0.140 | 0.042 | 0.041 | 0.049 | 0.047 | 0.050 | 0.0 [symbol] | 0.0 [symbol] 9 |
| RPF-full | | 0. [symbol] | 0.164 | 0.149 | 0.131 | 0.136 | 0. [symbol] 28 | 0.144 | 0.05 [symbol] | 0. [symbol] 0 | 0.065 | 0.048 | 0. [symbol] 0 | 0. [symbol] | 0.0 [symbol] |
| FedAvg | | 0. [symbol] 72 | 0.1 [symbol] 3 | 0.124 | 0.122 | 0.102 | 0. [symbol] 22 | 0.13 [symbol] | 0.043 | 0. [symbol] 40 | [symbol] | 0.054 | 0. [symbol] 50 | 0. [symbol] 4 | 0.04 [symbol] |
| DIFL | | 0. [symbol] | 0.140 | 0.126 | 0.116 | 0.107 | 0. [symbol] 20 | 0.130 | 0.043 | 0.037 | 0.046 | 0.053 | 0. [symbol] 47 | 0. [symbol] | 0.0 [symbol] |
| RPF-local | GRU | 0. [symbol] | 0.145 | 0.156 | 0.133 | 0.112 | 0. [symbol] | 0.138 | 0.0 [symbol] | [symbol] | 0.0 [symbol] 2 | 0.048 | 0.054 | 0.0 [symbol] 0 | 0.0 [symbol] |
| RPF-full | | 0. [symbol] | 0.151 | 0.138 | 0.122 | 0.144 | 0. [symbol] 16 | 0.14 [symbol] | 0.057 | [symbol] | 0.073 | 0.0 [symbol] 3 | 0.07 [symbol] | 0.050 | 0.0 [symbol] 3 |
| FedAvg | | 0. [symbol] 74 | 0.146 | 0.140 | 0.121 | 0.104 | 0. [symbol] 19 | 0.13 [symbol] | 0.0 [symbol] | 0. [symbol] | 0.0 [symbol] 2 | 0.048 | 0.054 | 0. [symbol] | 0.047 |
| DIFL | | 0. [symbol] | 0.1 [symbol] 3 | 0.129 | 0.. [symbol] 6 | 0.104 | 0. [symbol] 13 | 0.131 | 0.043 | 0.0 [symbol] | 0.05 [symbol] | 0.043 | 0. [symbol] | 0.0 [symbol] | 0.045 |
| RPF-local | CNN | 0. [symbol] 67 | 0.144 | 0.137 | 0.140 | 0.1 [symbol] | 0. [symbol] 2 | 0.1 [symbol] | 0.047 | 0.0 [symbol] | 0.0 [symbol] 4 | 0.0 [symbol] | 0.064 | 0.072 | 0.054 |
| RPF-full | | 0. [symbol] | 0.1 [symbol] 2 | 0.1 [symbol] 8 | 0.188 | 0.143 | 0. [symbol] 27 | 0.16 [symbol] | 0.0 [symbol] 7 | 0.0 [symbol] | 0.065 | 0.062 | 0.072 | 0. [symbol] | 0.062 |
| FedAvg | | 0. [symbol] | 0.15 [symbol] | 0.150 | 0.126 | 0.110 | 0. [symbol] | 0.138 | 0.050 | 0.0 [symbol] | 0.049 | 0.0 [symbol] 3 | 0.05 [symbol] | 0.070 | 0.0 [symbol] 3 |
| DIFL | | 0. [symbol] 73 | 0.14 [symbol] | 0.133 | 0. [symbol] 4 | 0.1 [symbol] | 0.134 | 0.134 | 0.048 | 0.040 | 0.046 | 0.055 | 0.045 | 0.070 | 0. [symbol] 51 |
| RPF-local | DNN | 0. [symbol] | 0.162 | 0.145 | 0. [symbol] 25 | 0.102 | 0.132 | 0.141 | 0.053 | 0. [symbol] 40 | 0.041 | 0.048 | 0.073 | 0.081 | 0.056 |
| RPF-full | | 0. [symbol] 87 | 0.1 [symbol] | 0.161 | 0.142 | 0.142 | 0.124 | 0.153 | 0.062 | 0.0 [symbol] | 0.0 [symbol] 4 | 0.033 | 0.071 | 0.0 [symbol] 9 | 0.0 [symbol] |
| FedAvg | | 0. [symbol] 75 | 0.171 | 0.147 | 0.141 | [symbol] | 0. [symbol] 19 | 0.14 [symbol] | 0.052 | 0.03 [symbol] | 0.041 | 0.0 [symbol] 0 | 0.070 | 0. [symbol] 55 | 0.051 |
| DIFL | | 0. [symbol] 80 | 0.157 | 0.143 | 0.129 | 0.101 | 0.128 | 0.139 | 0.052 | 0.03 [symbol] | 0.043 | 0.044 | 0.057 | 0.062 | 0. [symbol] |

[symbol]

indicates data missing or illegible when filed

TABLE IV
NMAE of different methods.

| | | WFD | | | | | | | SPD | | | | | | |
|---|---|---|---|---|---|---|---|---|---|---|---|---|---|---|---|
| Method | gᵢ(•) | 1 | 2 | 3 | 4 | 5 | 6 | Avg | 1 | 2 | 3 | 4 | 5 | 6 | Avg |
| RPF-local | LSTM | 0.238 | 0.256 | 0.169 | 0.2 [symbol] | 0.157 | 0.138 | 0.194 | 0.074 | 0.046 | [symbol] | [symbol] | 0.089 | 0.181 | 0.0 [symbol] |
| RPF-full | | 0.253 | 0.237 | 0.184 | [symbol] | 0.161 | 0.139 | 0.195 | 0.083 | 0.057 | 0.1 [symbol] 1 | 0.099 | 0.119 | 0.083 | 0.0 [symbol] |
| FedAvg | | 0.238 | 0.245 | 0.161 | 0. [symbol] | 0.153 | 0.138 | 0.190 | 0.064 | 0.041 | [symbol] | 0.073 | 0.062 | 0.07 [symbol] | 0.0 [symbol] |
| DIFL | | 0.2 [symbol] | 0.234 | 0.153 | 0.192 | 0.155 | 0.139 | 0.183 | 0.063 | 0.037 | 0.055 | 0. [symbol] 7 | 0.056 | 0.07 [symbol] | 0. [symbol] |
| RPF-local | GRU | 0.226 | 0.255 | 0.167 | 0.212 | 0.13 | 0.139 | 0.188 | 0.072 | 0.045 | 0.0 [symbol] 6 | 0.077 | [symbol] | 0. [symbol] 8 | 0.0 [symbol] 7 |
| RPF-full | | 0.2 [symbol] 4 | 0.253 | 0.173 | 0.214 | 0.1 [symbol] 9 | 0.138 | 0.192 | 0.096 | 0.36 | 0.10 [symbol] | 0.0 [symbol] | 0.109 | 0.075 | 0.0 [symbol] 7 |
| FedAvg | | 0.240 | 0.233 | 0.172 | 0. [symbol] | 0.163 | 0.138 | 0.1 [symbol] | 0.067 | 0.0 [symbol] | 0.057 | 0.085 | 0.091 | 0. [symbol] | 0.07 |
| DIFL | | 0. [symbol] | 0.207 | 0.151 | [symbol] | 0.129 | 0.136 | 0.174 | 0.062 | 0.041 | 0.058 | 0.0 [symbol] | 0.0 [symbol] 5 | 0.0 [symbol] | 0.0 [symbol] |
| RPF-local | CNN | 0.221 | 0.249 | [symbol] | 0.169 | 0.135 | 0.148 | 0.182 | 0.0 [symbol] | 0.035 | 0.061 | 0.072 | 0.08 | 0.172 | 0.085 |
| RPF-full | | 0.257 | 0.271 | 0.179 | 0.288 | 0.164 | 0.136 | 0.216 | [symbol] | 0.072 | 0.109 | 0.085 | 0.11 [symbol] | 0.081 | 0.091 |
| FedAvg | | 0.2 [symbol] | 0.212 | 0.178 | 0.20 [symbol] | 0.1 [symbol] 9 | 0.14 | 0.191 | 0.073 | 0.045 | 0. [symbol] 64 | 0.077 | 0.0 [symbol] 4 | 0.079 | 0.067 |
| DIFL | | 0.2 [symbol] | 0.231 | 0.165 | 0.193 | 0.139 | 0.135 | 0.179 | 0.064 | 0.045 | 0. [symbol] 1 | 0.078 | 0.058 | 0.092 | 0.0 [symbol] |
| RPF-local | DNN | 0.219 | [symbol] | [symbol] | 0.216 | 0.16 | 0.13 [symbol] | 0.192 | 0.0 [symbol] 5 | 0.04 [symbol] | 0.059 | 0.082 | [symbol] | 0.114 | 0.07 [symbol] |
| RPF-full | | 0.263 | 0.2 [symbol] 4 | 0.181 | 0.217 | 0.163 | 0.139 | 0.203 | 0.105 | 0.089 | 0.107 | 0.091 | 0.118 | 0. [symbol] 3 | 0.101 |
| FedAvg | | 0.245 | 0.2 [symbol] | 0.171 | 0.1 [symbol] | 0.163 | 0.14 [symbol] | 0.191 | 0.0 [symbol] 7 | 0.044 | 0.06 | 0.087 | 0. [symbol] | 0. [symbol] 4 | 0.074 |
| DIFL | | 0.215 | 0.275 | 0.168 | 0.1 [symbol] | 0.159 | 0.141 | 0.188 | 0.0 [symbol] 7 | 0.045 | 0.059 | 0.08 | [symbol] | 0.074 | 0.071 |

[symbol]

indicates data missing or illegible when filed

TABLE V
NRMSE of different methods.

| | | WFD | | | | | | | SPD | | | | | | |
|---|---|---|---|---|---|---|---|---|---|---|---|---|---|---|---|
| Method | gᵢ(•) | 1 | 2 | 3 | 4 | 5 | 6 | Avg | 1 | 2 | 3 | 4 | 5 | 6 | Avg |
| RPF-local | LSTM | 0.32 [symbol] | 0.34 | 0.298 | 0.286 | 0.27 [symbol] | 0.234 | 0.294 | 0.116 | 0.11 | [symbol] | 0.141 | 0.154 | [symbol] | 0.154 |
| RPF-full | | 0.348 | 0.321 | 0.321 | 0. [symbol] 73 | 0.28 | 0. [symbol] 11 | 0.292 | [symbol] | 0.121 | 0.196 | 0.171 | 0.202 | 0.117 | 0.153 |
| FedAvg | | 0.32 [symbol] | 0.3 [symbol] 2 | 0.252 | 0.27 [symbol] | 0.271 | 0.234 | 0.282 | [symbol] | 0.088 | 0.111 | 0.12 | 0.11 | 0.122 | 0.109 |
| DIFL | | 0.3 [symbol] | 0.314 | 0.245 | 0.2 [symbol] 5 | 0.2 [symbol] 3 | 0.234 | 0.273 | 0.098 | 0.083 | 0.1 [symbol] | 0.1 [symbol] 5 | 0.104 | 0.1 [symbol] | 0.103 |
| RPF-local | GRU | 0. [symbol] 12 | 0.34 | 0.292 | 0.293 | 0.2 [symbol] 3 | 0.233 | 0.283 | 0.1 [symbol] 8 | 0.10 [symbol] | 0.112 | 0.14 | 0.212 | 0.122 | 0.116 |
| RPF-full | | 0.274 | 0.336 | 0.298 | 0.296 | 0.279 | 0.234 | 0.286 | 0.1 [symbol] 8 | 0.116 | 0. [symbol] 7 | 0.149 | 0. [symbol] 4 | 0.114 | 0.15 [symbol] |
| FedAvg | | 0.330 | 0.317 | 0.303 | 0.250 | 0.235 | [symbol] | 0.280 | 0.1 [symbol] 4 | 0.101 | 0.113 | 0.151 | 0. [symbol] 0 | 0.099 | 0.121 |
| DIFL | | 0.311 | 0.2 [symbol] | 0.237 | 0.269 | 0.226 | 0.227 | 0.258 | 0.098 | 0.0 [symbol] | 0.114 | 0.126 | 0.116 | 0.1 [symbol] 1 | 0.107 |
| RPF-local | CNN | 0.299 | 0.332 | 0.283 | 0.235 | 0.229 | 0.1 [symbol] 6 | [symbol] | 0.101 | 0.107 | 0.117 | 0.118 | 0.129 | 0.2 [symbol] 1 | 0.132 |
| RPF-full | | 0.354 | 0.359 | 0.318 | 0.321 | 0.2 [symbol] 9 | 0.208 | 0.329 | 0.122 | 0.133 | 0.1 [symbol] 1 | 0.146 | 0.179 | 0.119 | 0.14 [symbol] |
| FedAvg | | 0.348 | 0.270 | 0.315 | 0.284 | 0.276 | 0.237 | 0.288 | 0.108 | 0.10 [symbol] | 0.123 | 0.130 | 0.114 | 0.115 | 0.115 |
| DIFL | | 0.278 | 0.277 | 0.251 | 0.270 | 0.242 | 0.210 | 0.255 | 0.103 | 0.093 | 0.1 [symbol] | 0.114 | 0.107 | 0.134 | 0.112 |
| RPF-local | DNN | [symbol] | 0.340 | 0.284 | 0.298 | 0.278 | 0.221 | 0.28 [symbol] | 0.104 | 0.103 | 0.113 | 0.139 | 0.154 | 0.179 | 0.132 |
| RPF-full | | 0.362 | 0.342 | 0.321 | 0.298 | 0.282 | 0.234 | 0.307 | 0.167 | 0.163 | 0.197 | 0.1 [symbol] | 0.198 | 0.128 | 0.168 |
| FedAvg | | 0.337 | 0.340 | 0.291 | 0.230 | 0.278 | 0.219 | 0.282 | 0.102 | 0.102 | 0.114 | 0.141 | 0.156 | 0.106 | 0.120 |
| DIFL | | 0. [symbol] 82 | 0.334 | 0.288 | 0.234 | 0.276 | 0.237 | 0.275 | 0.09 [symbol] | 0.0 [symbol] 7 | 0.116 | 0. [symbol] 23 | 0.127 | 0.131 | 0.115 |

[symbol]

indicates data missing or illegible when filed

As shown in Table IV, in terms of NMAE, the DIFL also significantly outperforms baselines. Compared with RPF-local, RPF-full and FedAvg, the DIFL obtains 4.7%, 10.2% and 4.2% improvements based on WPD and 5.1%, 30.2% and 18.0% improvements based on SPD. It is also observable from Table IV that DIFL also achieves the best NRMSE based on both WPD and SPD. Based on WPD, the performance of DIFL is 6.3%, 11.1% and 5.6% better than that of RPF-local, RPF-full, and FedAvg. Based on SPD, DIFL obtains 6.0%, 30.0% and 18.2% improvement compared with the baselines.

TABLE VI
Improvement of DIFL compared with different methods.

| | | WFD | | | SPD | | |
|---|---|---|---|---|---|---|---|
| Method | gᵢ(•) | CRPS | NMAE | NRMSE | CRPS | NMAE | NRMSE |
| RPF-local | LSTM | 7.14% | 5.67% | 7.14% | 6.12% | 31.82% | 33.12% |
| RPF-full | | 9.72% | 6.15% | 6.51% | 16.36% | 34.78% | 32.68% |
| FedAvg | | 2.26% | 3.68% | 3.19% | 4.17% | 3.23% | 5.50% |
| RPF-local | GRU | 5.07% | 7.45% | 8.83% | 8.16% | 5.97% | 7.76% |
| RPF-full | | 6.43% | 9.38% | 9.79% | 28.57% | 27.59% | 30.97% |
| FedAvg | | 2.24% | 7.45% | 7.86% | 4.26% | 10.00% | 11.57% |
| RPF-local | CNN | 8.22% | 1.65% | 2.67% | 5.56% | 23.53% | 15.15% |
| RPF-full | | 16.25% | 17.13% | 17.48% | 17.74% | 28.57% | 24.32% |
| FedAvg | | 2.90% | 6.28% | 11.46% | 3.77% | 2.99% | 2.61% |
| RPF-local | DNN | 1.42% | 2.08% | 3.51% | 12.50% | 6.58% | 12.88% |
| RPF-full | | 9.15% | 7.39% | 10.42% | 25.76% | 29.70% | 31.55% |
| FedAvg | | 3.47% | 1.57% | 2.48% | 3.92% | 4.05% | 4.17% |

TABLE VII
Comparison between DIFL and DLinear.

| | | | WFD | | | | | | | SPD | | | | | | |
|---|---|---|---|---|---|---|---|---|---|---|---|---|---|---|---|---|
| [symbol] | Method | gᵢ(•) | 1 | 2 | 3 | 4 | 5 | 6 | Avg | 1 | 2 | 3 | 4 | 5 | 6 | Avg |
| CRPS | DIFL | LSTM | [symbol] | [symbol] | [symbol] | [symbol] | [symbol] | [symbol] | [symbol] | [symbol] | [symbol] | [symbol] | [symbol] | [symbol] | [symbol] | [symbol] |
| | | GRU | [symbol] | [symbol] | [symbol] | [symbol] | [symbol] | [symbol] | [symbol] | [symbol] | [symbol] | [symbol] | [symbol] | [symbol] | [symbol] | [symbol] |
| | | CNN | [symbol] | [symbol] | [symbol] | [symbol] | [symbol] | [symbol] | [symbol] | [symbol] | [symbol] | [symbol] | [symbol] | [symbol] | [symbol] | [symbol] |
| | | DNN | [symbol] | [symbol] | [symbol] | [symbol] | [symbol] | [symbol] | [symbol] | [symbol] | [symbol] | [symbol] | [symbol] | [symbol] | [symbol] | [symbol] |
| | RPF-local | DLinear | [symbol] | [symbol] | [symbol] | [symbol] | [symbol] | [symbol] | [symbol] | [symbol] | [symbol] | [symbol] | [symbol] | [symbol] | [symbol] | [symbol] |
| NMAE | DIFL | LSTM | [symbol] | [symbol] | [symbol] | [symbol] | [symbol] | [symbol] | [symbol] | [symbol] | [symbol] | [symbol] | [symbol] | [symbol] | [symbol] | [symbol] |
| | | GRU | [symbol] | [symbol] | [symbol] | [symbol] | [symbol] | [symbol] | [symbol] | [symbol] | [symbol] | [symbol] | [symbol] | [symbol] | [symbol] | [symbol] |
| | | CNN | [symbol] | [symbol] | [symbol] | [symbol] | [symbol] | [symbol] | [symbol] | [symbol] | [symbol] | [symbol] | [symbol] | [symbol] | [symbol] | [symbol] |
| | | DNN | [symbol] | [symbol] | [symbol] | [symbol] | [symbol] | [symbol] | [symbol] | [symbol] | [symbol] | [symbol] | [symbol] | [symbol] | [symbol] | [symbol] |
| | RPF-local | DLinear | [symbol] | [symbol] | [symbol] | [symbol] | [symbol] | [symbol] | [symbol] | [symbol] | [symbol] | [symbol] | [symbol] | [symbol] | [symbol] | [symbol] |
| NRMSE | DIFL | LSTM | [symbol] | [symbol] | [symbol] | [symbol] | [symbol] | [symbol] | [symbol] | [symbol] | [symbol] | [symbol] | [symbol] | [symbol] | [symbol] | [symbol] |
| | | GRU | [symbol] | [symbol] | [symbol] | [symbol] | [symbol] | [symbol] | [symbol] | [symbol] | [symbol] | [symbol] | [symbol] | [symbol] | [symbol] | [symbol] |
| | | CNN | [symbol] | [symbol] | [symbol] | [symbol] | [symbol] | [symbol] | [symbol] | [symbol] | [symbol] | [symbol] | [symbol] | [symbol] | [symbol] | [symbol] |
| | | DNN | [symbol] | [symbol] | [symbol] | [symbol] | [symbol] | [symbol] | [symbol] | [symbol] | [symbol] | [symbol] | [symbol] | [symbol] | [symbol] | [symbol] |
| | RPF-local | DLinear | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

From Tables III-V, it is observable that DIFL achieves the best performance in most scenarios in terms of all three metrics. Such an observation implies that, although patterns of data from different types of renewable energy sources or renewable power plants have heterogenous characteristics, the flexibility of the DIFL enables tackling such a data-driven modeling challenge. Meanwhile, simply incorporating data of multiple renewable power plants as a large dataset for training may result in degraded modeling performance compared with modeling with only local data. It is possible that models trained via incorporated data might be too specific to the mixed information rather than the information of a specific system. By incorporating domain labels and a discriminator for distinguishing domain labels, the DIFL enables the domain-invariant feature learning on top of privacy-preserving. Such an effort may serve as the reason for leading to the enhanced prediction performance of DIFL. Furthermore, the performance of DIFL is also compared with the current state of the art model, DLinear [51] trained by local data. The result is presented in Table VII. From Table VII, it is observable that in most cases, DIFL outperforms DLinear. On average, DIFL obtains 2.56%, 4.74%, 6.60% improvements in terms of CRPS, NMAE and NRMSE based on WFD and 0.52%, 3.36% and 6.62% improvements of those metrics based on SPD by comparing with DLinear.

TABLE VIII
Significance of modeling paradigm selection and model structure selection in DRPSF.

| DAS1 | | | | | | | DAS2 | | | | | | |
|---|---|---|---|---|---|---|---|---|---|---|---|---|---|
| | WFD | | | SPD | | | | WFD | | | SPD | | |
| Modeling | Avg. | Avg. | Avg. | Avg. | Avg. | Avg. | Model | Avg. | Avg. | Avg. | Avg. | Avg. | Avg. |
| paradigm | CRPS | NMAE | NRMSE | CRPS | NMAE | NRMSE | structure | CRPS | NMAE | NRMSE | CRPS | NMAE | NRMSE |
| RPF-local | [symbol] | [symbol] | [symbol] | [symbol] | [symbol] | [symbol] | LSTM | [symbol] | [symbol] | [symbol] | [symbol] | [symbol] | [symbol] |
| RPF-full | [symbol] | [symbol] | [symbol] | [symbol] | [symbol] | [symbol] | GRU | [symbol] | [symbol] | [symbol] | [symbol] | [symbol] | [symbol] |
| FedAvg | [symbol] | [symbol] | [symbol] | [symbol] | [symbol] | [symbol] | CNN | [symbol] | [symbol] | [symbol] | [symbol] | [symbol] | [symbol] |
| DIFL | [symbol] | [symbol] | [symbol] | [symbol] | [symbol] | [symbol] | DNN | [symbol] | [symbol] | [symbol] | [symbol] | [symbol] | [symbol] |
| St. dev | [symbol] | [symbol] | [symbol] | [symbol] | [symbol] | [symbol] | St. dev | [symbol] | [symbol] | [symbol] | [symbol] | [symbol] | [symbol] |
| Range | [symbol] | [symbol] | [symbol] | [symbol] | [symbol] | [symbol] | Range | [symbol] | [symbol] | [symbol] | [symbol] | [symbol] | [symbol] |

[symbol]

indicates data missing or illegible when filed

Moreover, to explore the significance of selecting different modeling paradigms or different model structures in developing effective models for DRPSF, a comparative data analysis is conducted, and results are reported in Table VIII. Two analysis settings, DAS1 and DAS2, are designed. In DAS1, testing results in terms of CRPS, NMAE, and NRMSE of all model structures are averaged according to each of four modeling paradigms so that Avg. CRPS, Avg. NMAE, and Avg. NRMSE for each modeling paradigm can be obtained. In DAS2, testing results in terms of CRPS, NMAE, and NRMSE based on all modeling paradigms are averaged according to each of four model structures considered. Then, the Avg. CRPS, Avg. NMAE, and Avg. NRMSE for DAS2 can be obtained. Under such a design, DAS1 represents an analysis paying attention to modeling paradigm while DAS2 represents one paying attention to the model structure selected. One can further compute the standard deviation (St. dev.) and range of obtained Avg. CRPS, Avg. NMAE, and Avg. NRMSE. From Table VIII, it is observable that the standard deviation and range based on selecting modeling paradigms are much higher than those of selecting model structures. This finding implies that a careful selection of modeling paradigms can generate a higher impact on obtaining better DRPSF forecasting results than selecting model structures. Meanwhile, as reported in Tables III-VI, in most cases, the DIFL paradigm obtains comparable or better performance based on model structures considered. Hence, the value and effectiveness of the DIFL is further validated.

TABLE IX
Performance of constructed PIs with PINC = 0.9

| | | WFD | | | SPD | | |
|---|---|---|---|---|---|---|---|
| gᵢ(•) | Method | PICP | PINAW | ACE | PICP | PINAW | ACE |
| LSTM | RPF-local | 0.879 | 0.528 | −0.021 | 0.921 | 0.225 | 0.021 |
| | RPF-full | 0.855 | 0.519 | −0.045 | 0.843 | 0.263 | −0.057 |
| | FedAvg | 0.855 | 0.464 | −0.045 | 0.931 | 0.225 | 0.031 |
| | DIFL | 0.892 | 0.542 | −0.008 | 0.934 | 0.225 | 0.034 |
| GRU | RPF-local | 0.893 | 0.571 | −0.007 | 0.943 | 0.248 | 0.043 |
| | RPF-full | 0.818 | 0.371 | −0.082 | 0.870 | 0.294 | −0.030 |
| | FedAvg | 0.851 | 0.472 | −0.049 | 0.934 | 0.244 | 0.034 |
| | DIFL | 0.901 | 0.533 | 0.001 | 0.938 | 0.235 | 0.038 |
| CNN | RPF-local | 0.822 | 0.418 | −0.078 | 0.930 | 0.233 | 0.030 |
| | RPF-full | 0.815 | 0.364 | −0.085 | 0.855 | 0.279 | −0.045 |
| | FedAvg | 0.896 | 0.658 | −0.004 | 0.932 | 0.225 | 0.032 |
| | DIFL | 0.879 | 0.519 | −0.021 | 0.937 | 0.236 | 0.037 |
| DNN | RPF-local | 0.878 | 0.549 | −0.022 | 0.916 | 0.284 | 0.016 |
| | RPF-full | 0.894 | 0.648 | −0.006 | 0.837 | 0.291 | −0.043 |
| | FedAvg | 0.875 | 0.545 | −0.025 | 0.918 | 0.280 | 0.018 |
| | DIFL | 0.877 | 0.515 | −0.023 | 0.936 | 0.293 | 0.036 |

To further evaluate the performance, the PICP and PINAW of the prediction intervals generated by the estimated PDF of various modeling paradigms are presented next via setting PINC to 0.9. The results are shown in Table IX. It is observable that the DIFL method obtains the best or second best PICP and moderate level of PINAW in most scenarios.

TABLE X
Performance of constructed PIs with PINC = 0.9

| | | WFD | | | | SPD | | | |
|---|---|---|---|---|---|---|---|---|---|
| gᵢ(•) | Method | SPING | SUMMER | AUTUMN | WINTER | SPING | SUMMER | AUTUMN | WINTER |
| LSTM | RPF-local | 0.188 | 0.124 | 0.145 | 0.103 | 0.069 | 0.059 | 0.038 | 0.029 |
| | RPF-full | 0.170 | 0.127 | 0.145 | 0.134 | 0.067 | 0.056 | 0.032 | 0.041 |
| | FedAvg | 0.151 | 0.119 | 0.140 | 0.122 | 0.069 | 0.063 | 0.031 | 0.030 |
| | DIFL | 0.145 | 0.121 | 0.132 | 0.122 | 0.067 | 0.059 | 0.030 | 0.028 |

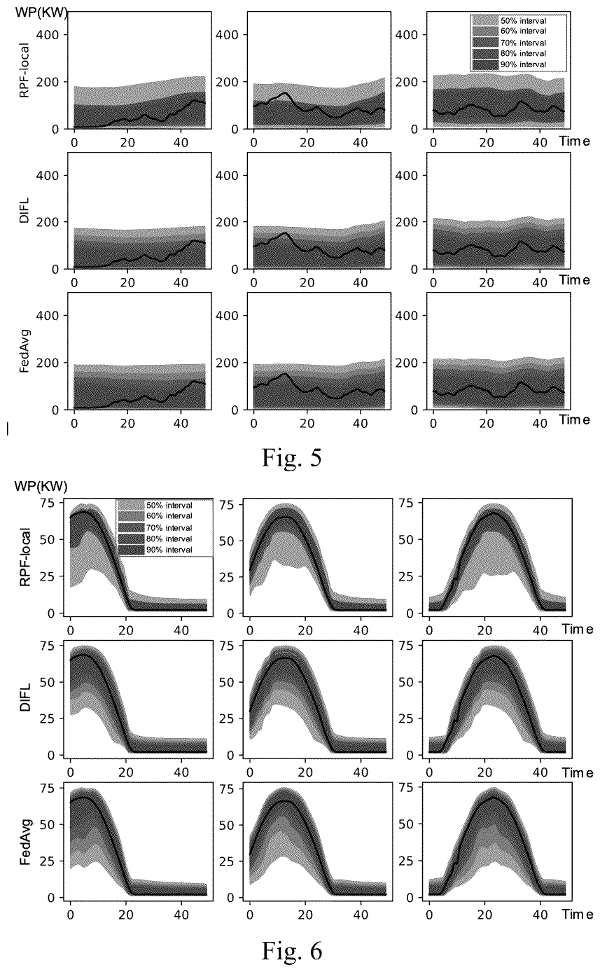

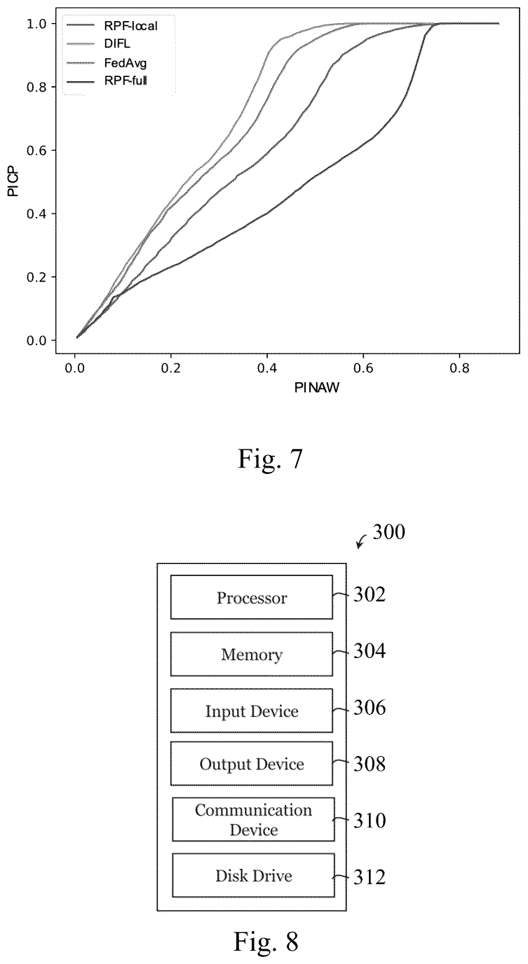

To visualize the obtained PIs of the DIFL, the PIs constructed by the RPF-local, DIFL and FedAvg are plotted using LSTM as the feature extractor based on datasets WFD and SPD in FIGS. 5 and 6 respectively. It is observable that PIs constructed by DIFL better fits to the power generation sequence. Meanwhile, the relationship between PICP and PINAW is also plotted based on randomly selected power plants in testing set of learning paradigms in FIG. 7. It is observable that the PICP converges to 1 when PINAW approaches the normalized upper bound of the wind speed and the DIFL could receive the similar PICP with a much smaller PINAW.

Finally, the robustness of DIFL is examined via performance evaluation under different seasons. Based on computational results aforementioned, the LSTM is considered as a quality candidate for gᵢ(·). Four modeling paradigms, RPF-local, RPF-full, FedAvg, and DIFL, are applied and compared. Results are reported in Table VIII. As shown in Table X, the DIFL still offers the best framework in most scenarios. Hence, DIFL is relatively less vulnerable by the season changes compared with other three baselines. Taking the above experiments into consideration, it can be concluded that DIFL obtains the state of the art performance in RPF tasks considered in this study.

In summary, one can see that the above exemplary embodiment provides a novel domain-invariant feature learning-based framework was developed to address a challenging but more advanced task, day-ahead probabilistic renewable power sequence forecasting with privacy preserving. The DIFL method enabled knowledge sharing among multiple sites without disclosing local data at each site. The DIFL consisted of multiple clients and a server. In each client, a feature extractor was developed to encode the input to latent features, and a probabilistic estimator was designed to provide probabilistic forecast according to the extracted latent features. On the other hand, the server was developed for two purposes: 1) aggregating the knowledge of local models and dispatching the aggregated parameters back to the clients, while 2) helping the feature extractors to generate domain invariant features via distinguishing the domain label of the features using a discriminator.

To verify the advantage of DIFL, the upper bound of the forecast error is derived, which was composed of modeling quality in the source domain as well as the divergence between source and target domain, via a mathematical analysis. Moreover, data collected from 6 commercial wind farms and 6 solar power plants were utilized in the experiments. Via benchmarking against a set of famous methods, results supported that the DIFL attained the state-of-the-art performance. However, this study does not explore performance evaluations under different weather conditions as weather conditions are unavailable in the considered datasets. Therefore, such an interesting and valuable problem can be studied in the future with weather conditions collected. Moreover, the current version of DIFL only entertains one network structure design for modelling all renewable power plants although forecasting performance advancement has been obtained. In the future, it is worth of extending the DIFL to accommodate considering different network structure designs for modelling different power plants with privacy preserving. The special attention will be devoted into studying new modeling principle of efficiently selecting appropriate model structure to enable higher modeling flexibility for capturing plant-wise heterogeneities.

Various method embodiments of the invention may be implemented using system implemented with hardware and/or software. For example, FIG. 8 shows a data processing system 300 in some embodiments of the invention. The data processing system 300 may be used to conduct the rotatable antenna array optimizing task as described above, and more generally, the data processing system 300 may be used to perform or to facilitate performing of one or more method embodiments of the invention.

The data processing system 300 generally comprises suitable components necessary to receive, store, and execute appropriate computer instructions, data, commands, and/or codes. The main components of the data processing system 300 are a processor 302 and a memory (storage) 304. The processor 302 may include one or more: CPU(s), MCU(s), GPU(s), logic circuit(s), Raspberry Pi chip(s), digital signal processor(s) (DSP), application-specific integrated circuit(s) (ASIC), field-programmable gate array(s) (FPGA), or any other digital or analog circuitry/circuitries configured to interpret and/or to execute program instructions and/or to process signals and/or information and/or data. The memory 304 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the memory 304. Computer instructions for executing or facilitating executing the method embodiments of the invention may be stored in the memory 304. The processor 302 and memory (storage) 304 may be integrated or separated (and operably connected).

Optionally, the data processing system 300 further includes one or more input devices 306. Example of such input device 306 include: keyboard, mouse, stylus, image scanner, microphone, tactile/touch input device (e.g., touch sensitive screen), image/video input device (e.g., camera), etc. The input device 306 may be used to receive user input. Optionally, the data processing system 300 further includes one or more output devices 308. Example of such output device 308 include: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive. The output device 308, e.g., the display, may be used to display the 3D medical image, images of the original slices, images of the reconstructed slices, images of the residual slices, etc. The data processing system 300 may further include one or more disk drives 312 which may include one or more of: solid state drive, hard disk drive, optical drive, flash drive, magnetic tape drive, etc. A suitable operating system may be installed in the data processing system 300, e.g., on the disk drive 312 or in the memory 304. The memory 304 and the disk drive 312 may be operated by the processor 302. Optionally, the data processing system 300 also includes a communication device 310 for establishing one or more communication links (not shown) with one or more other computing devices, such as servers, personal computers, terminals, tablets, phones, watches, IoT devices, or other wireless computing devices. The communication device 310 may include one or more of: a modem, a Network Interface Card (NIC), an integrated network interface, an NFC transceiver, a ZigBee transceiver, a Wi-Fi transceiver, a Bluetooth® transceiver, a radio frequency transceiver, a cellular (2G, 3G, 4G, 5G, above 5G, etc.) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 302, the memory 304 (optionally the input device(s) 306, the output device(s) 308, the communication device(s) 310 and the disk drive(s) 312, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network.

A person skilled in the art would appreciate that the data processing system 300 in FIG. 8 is merely an example and that the data processing system 300 can, in other embodiments, have different configurations (e.g., include additional components, has fewer components, etc.).

Although not required, one or more embodiments described with reference to the Figures can be implemented as an application programming interface (API) or as a series of libraries for use by a developer or can be included within another software application, such as a terminal or computer operating system or a portable computing device operating system. In one or more embodiments, as program modules include routines, programs, objects, components, and data files that assist in the performance of particular functions, the skilled person will understand that the functionality of the software application may be distributed across a number of routines, objects, and/or components to achieve the same functionality desired herein.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A computer-implemented method for probabilistic forecast of day-ahead power generation sequences of a plurality of renewable power plants, the method comprising:
a) for each one of a plurality of client devices, mapping its raw data input to latent features; the plurality of client devices each corresponding to a respective one of the plurality of renewable power plants;
b) transmitting a locally hosted forecasting model in the form of the latent features and model parameters of each said client device to a server; the plurality of client devices connected to the server,
c) aggregating the locally hosted forecasting models of the plurality of client devices at the server;
d) dispatching the aggregated models to the client devices;
e) updating the locally hosted forecasting model on each said client device based on the aggregated models; and
f) generating, at each said client device, power output sequence probabilistic forecasts based on the updated locally hosted forecasting model.

2. The computer-implemented method of claim 1, wherein for each one of the plurality of client devices, Step a) is conducted by a local feature extractor on the client device.

3. The computer-implemented method of claim 2, wherein the local feature extractor is a Deep Neural Network (DNN), a Convolutional Neural Networks (CNN), a Long Short-Term Memory networks (LSTM), or a Gated Recurrent Units (GRU).

4. The computer-implemented method of claim 2, wherein in Step a) the local feature extractor is assisted by a discriminator on the server in identifying domain-invariant features.

5. The computer-implemented method of claim 1, wherein the latent features are domain-invariant features.

6. The computer-implemented method of claim 1, wherein the model parameters are generated on each said client device by a local probabilistic estimator of the client device.

7. The computer-implemented method of claim 1, wherein the server comprises a global feature extractor, a global probabilistic estimator, and a discriminator.

8. The computer-implemented method of claim 7, wherein the global feature extractor is adapted to aggregate all said latent features from the plurality of client devices; the global probabilistic estimator adapted to aggregate all said model parameters from the plurality of client devices.

9. The computer-implemented method of claim 7, wherein the aggregated models comprise aggregated latent features and aggregated model parameters, which are used to update a local feature extractor and a local probabilistic estimator on each of the plurality of client devices.

10. The computer-implemented method of claim 7, wherein the discriminator is adapted to classify domain label of the latent features.

11. The computer-implemented method of claim 1, wherein Steps a)-e) are repeatedly performed in a plurality of iterations in order to train the locally hosted forecasting models.

12. The computer-implemented method of claim 6, further comprises a step of:
g) training, using a training dataset and a validation dataset, the local probabilistic estimator on at least one said client device to maximize a log likelihood of the probabilistic forecast of the local probabilistic estimator.

13. The computer-implemented method of claim 7, further comprises a step of:
h) training, using features generated by a plurality of local feature extractors respectively located on the plurality of client device from different domains, the discriminator to maximize a log likelihood that a forecast label equals a domain label.

14. The computer-implemented method of claim 2, further comprises a step of training the local feature extractor on at least one said client device using a combined loss of training a local probabilistic estimator on at least one said client device and training a discriminator on the server.

15. A system for probabilistic forecast of day-ahead power generation sequences of a plurality of renewable power plants, the system comprising:
a) one or more processors; and
b) memory storing one or more programs configured to be executed by the one or more processors, the one or more programs including instructions for executing a method according to claim 1.

16. A system for probabilistic forecast of day-ahead power generation sequences of a plurality of renewable power plants, the system comprising:
a) a server; and
b) a plurality of client devices connected to the server;
wherein the server is adapted to aggregate locally hosted forecasting models from the plurality of client devices, and to dispatch the aggregated models to the client devices; and
wherein the locally hosted forecasting models received by the server comprises latent features and model parameters of the locally hosted forecasting models.

17. A non-transitory computer-readable storage medium storing one or more programs configured to be executed by one or more processors, the one or more programs including instructions for executing a method according to claim 1.
